(19) United States
(12) Patent Application Publication
(10) Pub. No.: US 2026/0162526 A1
(43) Pub. Date: Jun. 11, 2026

(54) GREENHOUSE GAS EMISSION EVALUATION APPARATUS, EMISSION EVALUATION SYSTEM, EMISSION EVALUATION METHOD, AND STORAGE MEDIUM

(71) Applicant: NEC Corporation, Minato-ku, Tokyo (JP)

(72) Inventor: Kosei KOBAYASHI, Tokyo (JP)

(73) Assignee: NEC Corporation, Minato-ku, Tokyo (JP)

(21) Appl. No.: 18/709,578

(22) PCT Filed: Mar. 4, 2022
(86) PCT No.: PCT/JP2022/009449

§ 371 Date: May 13, 2024

(51) Int. Cl. G08G 1/01; G06V 20/54; G08G 1/015; G08G 1/0969

(52) U.S. Cl. CPC G08G 1/0145; G06V 20/54; G08G 1/015; G08G 1/0969; G06V 2201/08

(57) ABSTRACT

A greenhouse gas emission evaluation apparatus (102) includes: an analysis unit (103) that generates an analysis result by analyzing state information related to a vehicle C traveling on a road; and an emission evaluation unit (104) that evaluates an amount of greenhouse gas emission accompanying travel of the vehicle C by using an evaluation model for evaluating an amount of greenhouse gas emission accompanying travel of a vehicle C with the analysis result as input data.

### TECHNICAL FIELD

The present invention relates to a greenhouse gas emission evaluation apparatus, an emission evaluation system, an emission evaluation method, and a storage medium.

### BACKGROUND ART

Carbon dioxide (CO₂) is well known as one of atmospheric gases with a function of raising the temperature of the earth. For example, Patent Document 1 describes computation of an amount of emission of carbon dioxide (an amount of carbon dioxide emission) Z2 excessively emitted due to traffic congestion. In Patent Document 1, the amount of carbon dioxide emission Z2 is found as the total sum of the products of a loss time Tloss, the number of vehicles N, and an amount of CO₂ emission in a series of congested sections and congestion periods JT.

The loss time Tloss is defined in Patent Document 1 to be the difference between a travel time required for traveling the distance Ki of a section Pi, i+1 at the average travel velocity of a vehicle detected by a detection apparatus, and a travel time required for traveling the same distance at a congestion velocity JS.

Further, for example, Patent Document 2 discloses a technology for computing an amount of CO₂ by computing an amount of CO₂ emitted from a census section, roughly classifying the whole country into blocks, and totaling amounts of emission from census sections for each urban district/non-urban district in each of the blocks.

Patent Document 2 describes that a CO₂ emission estimation model is built based on the following concept.

A. As for a census section, a traffic volume for 24 hours a day, 365 days a year, a total of 8760 hours is estimated, and a total travel distance for each travel velocity in each time period is estimated by using the Q-V formula. Note that the Q-V formula is described to be set based on road traffic census data for each road type, for each number of lanes, for each urban/non-urban district, for each traffic light density, and for each congested/uncongested state.

B. An amount of CO₂ emission is output through a basic emission unit for each travel velocity.

C. As for municipal roads, a travel velocity is set to 18 km/h in urban districts and 28 km/h (a value of the average travel velocity in congestion in ordinary prefectural roads) in non-urban districts regardless of a degree of congestion, and an amount of CO₂ emission is estimated.

### RELATED DOCUMENT

### Patent Document

Patent Document 1: International Application Publication No. WO 2020/065972
Patent Document 2: Japanese Patent Application Publication No. 2007-328769

### DISCLOSURE OF THE INVENTION

### Technical Problem

While Patent Document 1 discloses a technology for computing an amount of carbon dioxide emission Z2 excessively emitted due to traffic congestion, the document does not disclose a technology for evaluating an amount of CO₂ (carbon dioxide) itself emitted from a vehicle.

Further, Patent Document 2 does not disclose a technology for real-time evaluation of an amount of CO₂ emitted from a vehicle, based on the concept of the aforementioned CO₂ emission estimation model.

The present invention has been made in view of the circumstances described above, and one of objectives of the present invention is to improve real-time performance related to evaluation of an amount of greenhouse gas emission accompanying travel of a vehicle.

### Solution to Problem

In order to achieve the aforementioned object, a greenhouse gas emission evaluation apparatus according to a first aspect of the present invention includes:

an analysis unit that generates an analysis result including vehicle types of one or more vehicles by analyzing state information indicating states of the one or more vehicles traveling on a road; and an emission evaluation unit that evaluates an amount of greenhouse gas emission accompanying travel of the one or more vehicles by using an evaluation model for evaluating an amount of greenhouse gas emission accompanying travel of a vehicle with the analysis result as input data.

In order to achieve the aforementioned object, a greenhouse gas emission evaluation system according to a second aspect of the present invention includes:
at least one of an image capture unit that generates image information acquired by capturing an image of the road as the state information and an on-vehicle apparatus that generates vehicle information about a vehicle traveling on the road as the state information; and
the aforementioned greenhouse gas emission evaluation apparatus.

In order to achieve the aforementioned object, a greenhouse gas emission evaluation method according to a third aspect of the present invention includes:
generating an analysis result by analyzing state information indicating states of one or more vehicles traveling on a road; and
evaluating an amount of greenhouse gas emission accompanying travel of the vehicle by using an evaluation model for evaluating an amount of greenhouse gas emission accompanying travel of a vehicle with the analysis result as input data.

In order to achieve the aforementioned object, a storage medium according to a fourth aspect of the present invention is a storage medium on which a program is recorded, the program causing a computer to execute:
generating an analysis result by analyzing state information indicating states of one or more vehicles traveling on a road; and
evaluating an amount of greenhouse gas emission accompanying travel of the vehicle by using an evaluation model for evaluating an amount of greenhouse gas emission accompanying travel of a vehicle with the analysis result as input data.

### Advantageous Effects of Invention

The present invention can improve real-time performance related to evaluation of an amount of greenhouse gas emission accompanying travel of a vehicle.

### BRIEF DESCRIPTION OF THE DRAWINGS

FIG. 1 is a diagram of surveilled regions P1 to P14 and roads R1 to R4 according to a first example embodiment viewed from above.

FIG. 2 is a diagram illustrating a configuration of a greenhouse gas emission evaluation system according to the first example embodiment.

FIG. 3 is a diagram illustrating a configuration of an analysis unit according to the first example embodiment.

FIG. 4 is a diagram illustrating an example of an analysis result according to the first example embodiment.

FIG. 5 is a diagram illustrating a configuration of an emission evaluation unit according to the first example embodiment.

FIG. 6 is a diagram illustrating an example of a physical configuration of a greenhouse gas emission evaluation apparatus according to the first example embodiment.

FIG. 7 is an example of a flowchart of greenhouse gas emission evaluation processing according to the first example embodiment.

FIG. 8 is an example of a flowchart of analysis processing according to the first example embodiment.

FIG. 9 is a diagram illustrating examples of a vehicle C and a vehicle model that are determined from state information of the surveilled region P1 at a time T1 and a time T2.

FIG. 10 is a diagram illustrating an example of vehicle model data.

FIG. 11 is an example of a flowchart of evaluation generation processing according to the first example embodiment.

FIG. 12 is a diagram illustrating a first example of an evaluation map.

FIG. 13 is a diagram illustrating a second example of an evaluation map.

FIG. 14 is a diagram illustrating a third example of an evaluation map.

FIG. 15 is a diagram illustrating an example of a graph displayed on a display unit.

FIG. 16 is a diagram illustrating an example of ranking of amounts of CO₂ emission displayed on the display unit.

FIG. 17 is a diagram illustrating a configuration of a greenhouse gas emission evaluation system according to a second example embodiment.

FIG. 18 is a diagram illustrating a configuration of an analysis unit according to the second example embodiment.

FIG. 19 is a diagram illustrating an example of an analysis result according to the second example embodiment.

FIG. 20 is a diagram illustrating a configuration of an emission evaluation unit according to the second example embodiment.

FIG. 21 is an example of a flowchart of greenhouse gas emission evaluation processing according to the second example embodiment.

FIG. 22 is an example of a flowchart of analysis processing according to the second example embodiment.

FIG. 23 is an example of a flowchart of evaluation generation processing according to the second example embodiment.

FIG. 24 is a diagram illustrating a configuration of a greenhouse gas emission evaluation system according to a third example embodiment.

FIG. 25 is a diagram illustrating a configuration of an analysis unit according to the third example embodiment.

FIG. 26 is a diagram illustrating an example of an analysis result according to the third example embodiment.

FIG. 27 is an example of a flowchart of greenhouse gas emission evaluation processing according to the third example embodiment.

FIG. 28 is a diagram illustrating an example of an analysis result according to the third example embodiment.

FIG. 29 is a diagram illustrating a configuration of a greenhouse gas emission evaluation system according to a fourth example embodiment.

FIG. 30 is a diagram illustrating a configuration of a greenhouse gas emission evaluation system according to a fifth example embodiment.

FIG. 31 is an example of a flowchart of learning processing according to the fifth example embodiment.

### DESCRIPTION OF EMBODIMENTS

Example embodiments of the present invention will be described below by using drawings. Note that in every drawing, similar components are given similar signs, and description thereof is omitted as appropriate.

### First Example Embodiment

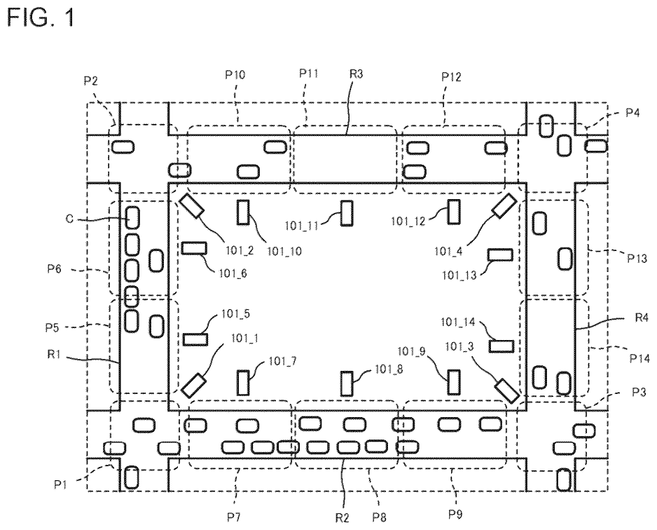

FIG. 1 is a diagram of surveilled regions P1 to P14 and roads R1 to R4 according to the present example embodiment viewed from above. A greenhouse gas emission evaluation system (hereinafter also simply expressed as an “evaluation system”) 100 according to a first example embodiment is a system for evaluating an amount of greenhouse gas emission accompanying travel of a vehicle C in the surveilled regions P1 to P14, as illustrated in FIG. 1.

Each of the surveilled regions P1 to P14 is a region in which surveillance for evaluating an amount of greenhouse gas emission is performed. Each of the surveilled regions P1 to P14 according to the present example embodiment is determined in relation to the roads R1 to R4. Specifically, the surveilled regions P1 to P4 are determined in relation to intersections of the roads R1 to R4, and the surveilled regions P5 to P14 are determined in relation to sections appropriately determined on the roads R1 to R4.

Unless being particularly distinguished from each other, the surveilled regions P1 to P14 are hereinafter also simply expressed as “surveilled regions P.” Unless being particularly distinguished from each other, the roads R1 to R4 are also simply expressed as “roads R.”

Note that the surveilled regions P are not limited to regions determined in relation to the roads R such as the roads R, sections on the roads R, and intersections of the roads R, and for example, may be appropriate regions such as one of municipalities or part thereof, one of prefectures or part thereof, or the whole country or part thereof. Further, at least one surveilled region P has only to be set, and the shape and the size of each of the at least one surveilled region P may be appropriately set.

Greenhouse gas is an atmospheric gas with a function of raising the temperature of the earth, examples of the gas including gas emitted from a vehicle C, carbon dioxide (CO₂), methane (CH₄), and dinitrogen monoxide (N₂O). A case of greenhouse gas an amount of emission of which is evaluated by the evaluation system 100 according to the present example embodiment is CO₂ will be described as an example. Note that one or a plurality of types of greenhouse gas may be appropriately selected as gas an amount of emission of which is evaluated by the evaluation system 100.

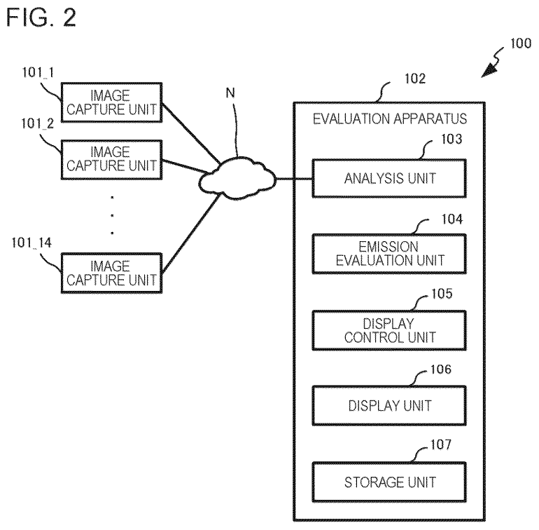

As illustrated in FIG. 2, the evaluation system 100 includes a plurality of image capture units 101_1 to 101_14 and an emission evaluation apparatus 102.

An “emission evaluation system” and an “emission evaluation apparatus” are hereinafter also expressed as an “evaluation system” and an “evaluation apparatus,” respectively, and are similarly expressed in diagrams.

Each of the image capture units 101_1 to 101_14 is an example of an apparatus for acquiring state information indicating states of one or more vehicles C traveling on a road R in a surveilled region P. Each of the image capture units 101_1 to 101_14 is connected to the evaluation apparatus 102 through a network N and can transmit and receive information to and from the evaluation apparatus 102. The network N is a wired or wireless communication network, or a communication network built by combining the two.

Each of the image capture units 101_1 to 101_14 according to the present example embodiment is a camera placed on a road R in such a way as to capture an image of the road R. Each unit is provided in association with each of the surveilled regions P1 to P14 and captures an image of a vehicle C traveling in each of the surveilled regions P1 to P14.

Unless being particularly distinguished from each other, the “image capture units 101_1 to 101_14” are hereinafter also expressed as “image capture units 101.”

For example, each image capture unit 101 captures an image of a road R in an associated surveilled region P at predetermined time intervals such as 1/30-second intervals and generates image information including the captured image. The image capture unit 101 transmits state information at least including the generated image information to the evaluation apparatus 102 through the network N.

In other words, state information according to the present example embodiment includes image information acquired by capturing an image of a road R by an image capture unit 101. In addition, state information according to the present example embodiment includes a region identifier (ID) being information for identifying a surveilled region P related to the image information and time information indicating a time related to a state indicated by the image information.

Examples of a region ID include a sign assigned to a surveilled region P, a sign assigned to an image capture unit 101 associated with a surveilled region P, and an address of an image capture unit 101 associated with a surveilled region P in the network N. A sign may be appropriately determined and, for example, is represented by a combination of a character, a numeral, and/or a symbol.

Time information is typically information indicating a time at which image information is generated and may indicate a time at which image information is transmitted or the like.

A series of processing operations in each image capture unit 101 from generation of image information to transmission of state information to the evaluation apparatus 102 is preferably performed in real time. In real time means practically immediately or in real time, and the same holds for the following descriptions. In other words, processing executed in real time includes occurrence of a time delay required for communication, processing, or the like of information.

Note that vehicles C traveling on a road R include not only a vehicle C travelling on the road R but also a vehicle C being temporarily stopped on the road in order to, for example, wait for the traffic lights to change. Further, vehicles C traveling on the road R may include a vehicle C on the road and for example, may further include a stopped vehicle being stopped on the road R for a relatively short time and a parked vehicle being stopped on the road R for a relatively long time.

### <Functional Configuration of Greenhouse Gas Emission Evaluation Apparatus (Evaluation Apparatus) 102>

As illustrated in FIG. 2, the evaluation apparatus 102 according to the present example embodiment functionally includes an analysis unit 103, an emission evaluation unit 104, a display control unit 105, a display unit 106, and a storage unit 107.

When acquiring state information of a surveilled region P from an image capture unit 101 in real time, the analysis unit 103 generates an analysis result in real time by analyzing the acquired state information. The analysis unit 103 stores the generated analysis result into the storage unit 107.

Analysis processing in the analysis unit 103 is typically executed by using the latest state information every time state information is acquired from an image capture unit 101. Note that the analysis processing in the analysis unit 103 may be executed at predetermined time intervals, such as being executed by using the latest state information every time a plurality of pieces of state information about one surveilled region P are acquired. The time intervals at which the analysis processing is executed may be changed based on conges status of a road R.

An analysis result is information acquired by analyzing state information and at least includes vehicle types of one or more vehicles C included in the state information.

A vehicle type is a type of a vehicle C classified in accordance with a predetermined criterion. Vehicle types according to the present example embodiment are classified by a composition of drive energy used in a vehicle C and include an electric car, a fuel cell car (also referred to as a hydrogen car), a hybrid car, and an engine (internal combustion) car.

An electric car is a car externally charging a storage battery equipped on a vehicle C and using electric power of the storage battery as drive energy. A fuel cell car is a car using electric power generated by using externally supplied hydrogen as drive energy.

A hybrid car is a car using both fuel and electric power as drive energy. An engine (internal combustion) car is a car using only fuel such as gasoline or light oil as drive energy.

Note that vehicle types classified by a composition of drive energy are not limited to the above and may be further subdivided, or a plurality of vehicle types may be grouped into one type. For example, an engine car may be further subdivided into a gasoline car, a diesel car, and the like. Further, for example, an electric car and a fuel cell car may be grouped into one category as cars using only electric power as drive energy. Furthermore, the criterion for classifying vehicle types is not limited to a composition of drive energy and for example, may be a vehicle model.

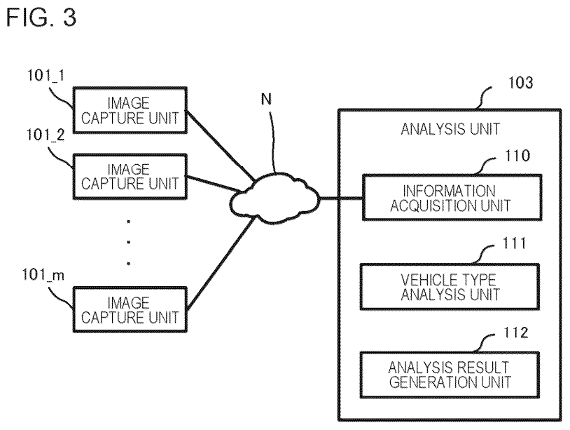

Specifically, as illustrated in FIG. 3, the analysis unit 103 functionally includes an information acquisition unit 110, a vehicle type analysis unit 111, and an analysis result generation unit 112.

The information acquisition unit 110 acquires state information from each image capture unit 101 through the network N. The information acquisition unit 110 holds the acquired state information.

The vehicle type analysis unit 111 determines the vehicle type of each of one or more vehicles C traveling on a road R in a surveilled region P by analyzing state information acquired by the information acquisition unit 110. Specifically, when an image of the road R indicated by the state information includes one or more vehicles, the vehicle type analysis unit 111 determines the vehicle type of each of the one or more vehicles.

Specifically, for example, the vehicle type analysis unit 111 determines the vehicle model of each of one or more vehicles C included in an image of a road R indicated by state information. Then, the vehicle type analysis unit 111 determines the vehicle type of each of the one or more vehicles C, based on the determined vehicle model of the vehicle C.

The analysis result generation unit 112 generates an analysis result including a vehicle type determined by the vehicle type analysis unit 111. The analysis result generation unit 112 stores the analysis result into the storage unit 107.

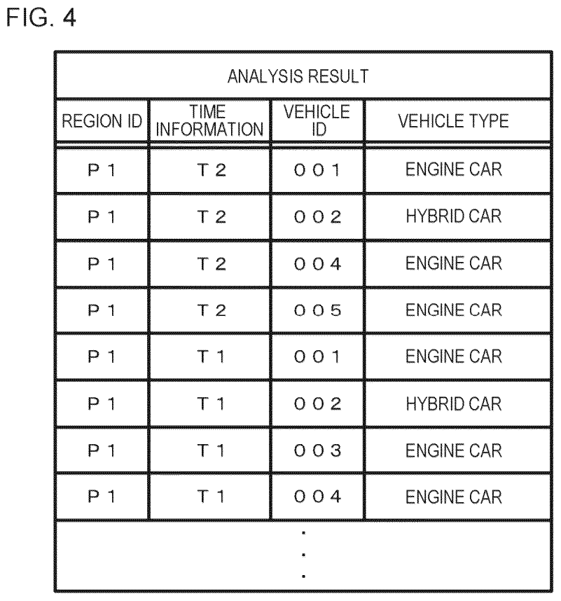

FIG. 4 illustrates an example of an analysis result generated by the analysis result generation unit 112 according to the present example embodiment. A region ID, time information, a vehicle ID, and a vehicle type are associated with each other in an analysis result according to the present example embodiment. A region ID and time information included in an analysis result are the same as those included in state information being a basis of generation of the analysis result. A vehicle ID is information for identifying a vehicle C included in state information. A vehicle ID and a vehicle type included in an analysis result are a vehicle ID and a vehicle type of a vehicle C included in state information being the basis of generation of the analysis result.

FIG. 2 is referred to again.

By using a previously prepared evaluation model, the emission evaluation unit 104 evaluates an amount of greenhouse gas emission accompanying travel of one or more vehicles C traveling on a road R in a surveilled region P. Then, the emission evaluation unit 104 generates evaluation information including the evaluation result and stores the evaluation information into the storage unit 107.

The evaluation model according to the present example embodiment is a model for evaluating an amount of greenhouse gas emission accompanying travel of a vehicle C in each surveilled region P with an analysis result generated by the analysis result generation unit 112 as input data. As a result of evaluation, the evaluation model outputs an evaluation value of an amount of greenhouse gas emission accompanying travel of a vehicle C in each surveilled region P.

An example of an evaluation value as a result of evaluation of an amount of greenhouse gas emission accompanying travel of a vehicle C in a surveilled region P being represented by an estimated value of an amount of CO₂ emission from the vehicle C in the surveilled region P at each time will be described in the present example embodiment.

Note that an evaluation value of an amount of greenhouse gas emission is not limited to an estimated value of an amount of CO₂ emission and for example, may be concentration of atmospheric greenhouse gas (such as CO₂ concentration) in a surveilled region P or an amount of fuel usage when fuel is used under a predetermined condition. A case of using fuel under a predetermined condition refers to, for example, a case of a standard gasoline vehicle traveling under a predetermined travel condition. Further, an evaluation value of an amount of greenhouse gas emission is not limited to a numerical value, and for example, may be an indicator indicating the magnitude of the evaluation value in steps, such as a character or a symbol. The number of steps into which the magnitude of an evaluation value is segmented may be appropriately determined.

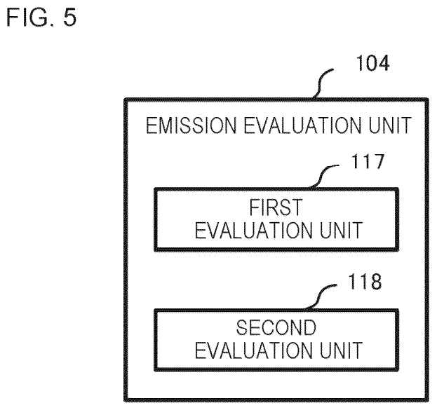

Specifically, for example, the emission evaluation unit 104 includes a first evaluation unit 117 and a second evaluation unit 118, as illustrated in FIG. 5.

By using an evaluation model, the first evaluation unit 117 evaluates an amount of CO₂ emission accompanying travel of each of one or more vehicles C traveling on a road R in a surveilled region P. The first evaluation unit 117 according to the present example embodiment finds an estimated value of an amount of CO₂ emission accompanying travel of each of one or more vehicles C in a surveilled region P at each time.

Then, the first evaluation unit 117 generates first evaluation information including an estimated value as a result of the evaluation and stores the generated information into the storage unit 107. First evaluation information generated by the first evaluation unit 117 includes, for each combination of a surveilled region P and a time, an estimated value of an amount of CO₂ emission from each vehicle C traveling in the surveilled region P.

The second evaluation unit 118 evaluates an amount of CO₂ emission accompanying travel of all of one or more vehicles traveling on a road R in a surveilled region P.

The second evaluation unit 118 according to the present example embodiment finds the total sum of estimated values found by the first evaluation unit 117, that is, estimated values of amounts of CO₂ emission accompanying travel of the one or more vehicles in the surveilled region P at each time. Thus, the second evaluation unit 118 finds an estimated value of an amount of CO₂ emission accompanying travel of all of the one or more vehicles in the surveilled region P at each time.

Then, the second evaluation unit 118 generates second evaluation information including an estimated value as a result of the evaluation and stores the generated information into the storage unit 107. Second evaluation information generated by the second evaluation unit 118 includes, for each combination of a surveilled region P and a time, an estimated value of an amount of CO₂ emission from all of the one or more vehicles traveling in the surveilled region P.

The display control unit 105 generates display information, based on evaluation information including first evaluation information and second evaluation information that are generated by the emission evaluation unit 104, and outputs the generated display information to be displayed by the display unit 106. The display unit 106 displays various types of information including display information output from the display control unit 105.

Display information may be created by totalizing estimated values included in evaluation information within a predetermined totalization range such as for each section of a road R, for each surveilled region P, or for each area including a plurality of surveilled regions P. Display information may be created by totalizing estimated values included in evaluation information for each predetermined period. For example, the predetermined period may be an appropriate period such as a time period acquired by segmenting one day by a fixed time, a time period acquired by segmenting one day by different lengths of time (such as morning, daytime, night, and midnight), one day, one week, or one month.

Further, evaluation information may be created based on a history of the evaluation information or may be created based on the latest evaluation information. By referring to display information based on a history of evaluation information, status of an amount of CO₂ emission based on a period being referred to can be recognized. By referring to display information based on the latest evaluation information, status of a current amount of CO₂ emission can be recognized in real time.

Various types of information such as evaluation information are stored in the storage unit 107. For example, when display information is created based on a history of evaluation information, the display control unit 105 acquires past evaluation information from the storage unit 107 and creates display information.

### <Physical Configuration of Greenhouse Gas Emission Evaluation Apparatus (Evaluation Apparatus) 102>

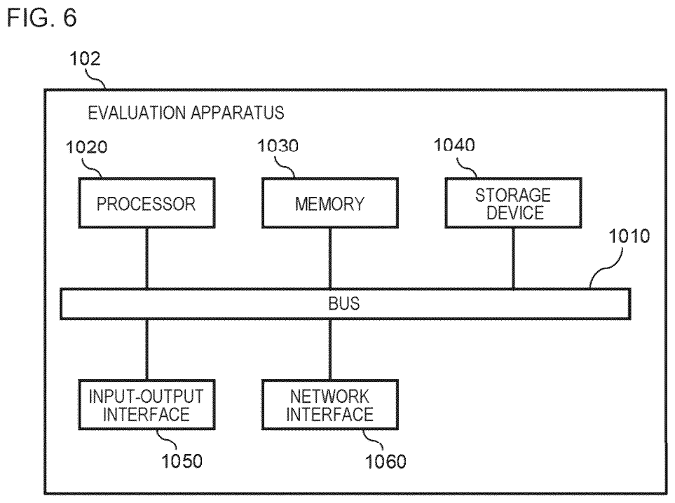

The evaluation apparatus 102 is physically a general-purpose computer or the like and includes a bus 1010, a processor 1020, a memory 1030, a storage device 1040, an input-output interface 1050, and a network interface 1060, as illustrated in FIG. 6.

The bus 1010 is a data transmission channel for the processor 1020, the memory 1030, the storage device 1040, the input-output interface 1050, and the network interface 1060 to transmit and receive data to and from each other. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a hard disk drive (HDD), a solid-state drive (SSD), a memory card, a read-only memory (ROM), or the like. Program modules for providing the functions of the evaluation apparatus 102 are stored in the storage device 1040. By reading each program module into the memory 1030 and executing the program module by the processor 1020, each function related to the program module is provided.

The input-output interface 1050 includes a touch panel, a keyboard, or a mouse as an interface for a user to input information and includes a liquid crystal panel or an organic electro-luminescence (EL) panel as an interface for providing information to the user.

The network interface 1060 is an interface for connecting the evaluation apparatus 102 to the network N.

<Operation of greenhouse gas emission evaluation system (evaluation system) 100>

An example of the operation of the evaluation system 100 will be described below.

Each image capture unit 101 generates state information by capturing an image of an associated surveilled region P in real time and transmits the state information. The information acquisition unit 110 acquires state information from each image capture unit 101 through the network N in real time.

The evaluation apparatus 102 executes greenhouse gas emission evaluation processing (hereinafter also simply expressed as “evaluation processing”) for evaluating an amount of greenhouse gas (CO₂ in the present example embodiment) emission accompanying travel of a vehicle C in a surveilled region P. The evaluation processing is repeatedly executed for each of the surveilled regions P1 to P14 every time the information acquisition unit 110 acquires state information from an image capture unit 101 with the state information (that is, the latest state information) as a processing target.

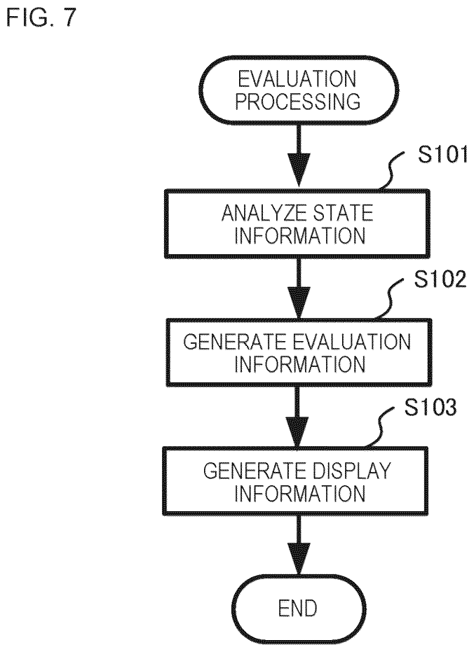

FIG. 7 illustrates an example of a flowchart of the evaluation processing according to the present example embodiment.

As illustrated in the diagram, when acquiring state information, the analysis unit 103 analyzes the acquired latest state information (Step S101).

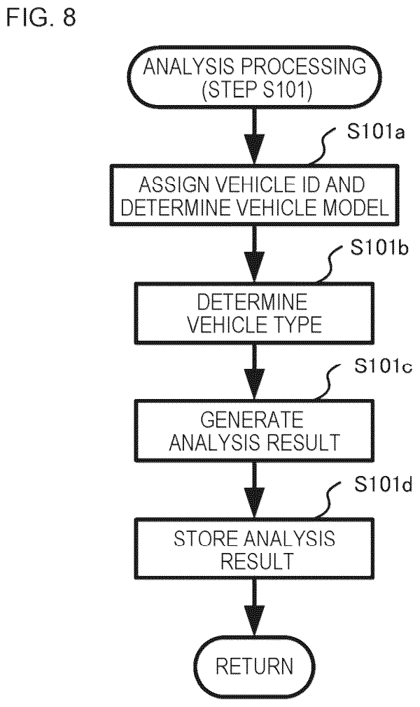

FIG. 8 illustrates an example of a flowchart of analysis processing (Step S101). As illustrated in the diagram, when image information in the state information includes one or more vehicles C, the vehicle type analysis unit 111 assigns a vehicle ID to each of the one or more vehicles C and determines the vehicle model of the vehicle C (Step S101a).

Various conventional image processing technologies may be applied to the determination of the vehicle model in Step S101a, and for example, a technology using pattern matching or a learning model trained by machine learning is preferably applied.

When a learning model trained by machine learning is used, a trained vehicle model determination model undergoing machine learning for determining a vehicle model is used as a learning model. The latest state information and past state information that are acquired by the information acquisition unit 110 are input to the vehicle model determination model.

Past state information has only to be state information related to status of a surveilled region P preceding the latest state information by a predetermined time and for example, is state information generated immediately before the latest state information.

In response to the inputs, when an image of a road R indicated by the latest state information includes one or more vehicles C, the vehicle model determination model outputs information in which the vehicle ID of each of the one or more vehicles C and the vehicle model of the vehicle are associated with each other.

As described above, a vehicle ID is information for identifying each of one or more vehicles C included in state information and, for example, when a common vehicle C is included in the latest state information and immediately preceding state information, a common vehicle ID is assigned to the common vehicle C. For example, a vehicle ID may be assigned by the vehicle type analysis unit 111 in accordance with a predetermined rule.

For example, supervised learning using training data in which an image of a vehicle and the vehicle model are associated with each other is preferably performed in machine learning of the vehicle model determination model. Further, for example, a plurality of pieces of image information acquired by capturing images of a road R may be used in machine learning of the vehicle model determination model. Supervised learning using training data including whether one or a plurality of vehicles C included in the plurality of pieces of image information are common and the vehicle model of each of the one or a plurality of vehicles C as a correct answer is preferably performed in the machine learning in this case.

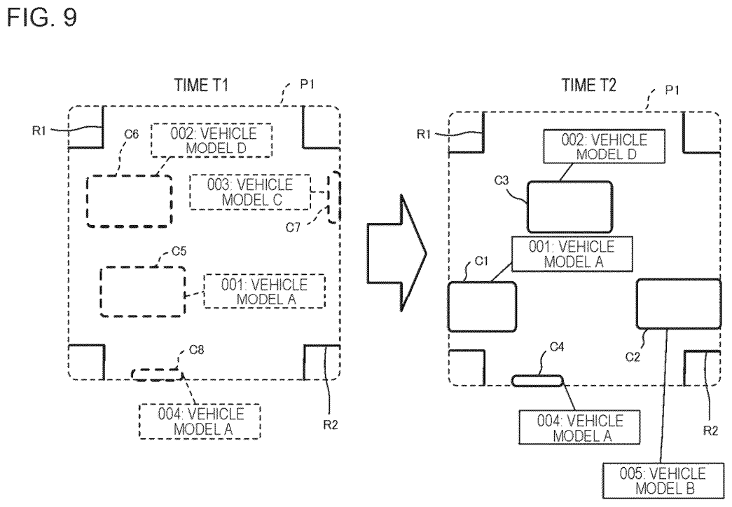

FIG. 9 is a diagram illustrating an example of a vehicle C and a vehicle model that are determined by the vehicle type analysis unit 111 from state information (image information) of a surveilled region P1 at a time T1 and a time T2. The time T2 is a time related to the latest state information. The time T1 is a time related to state information immediately before the time T2. In the diagram, vehicles C included in the state information at the time T2 are indicated by solid lines, and vehicles C included in the state information at the time T1 are indicated by dotted lines.

In the example in the diagram, the state information at the time T2 includes part of vehicles C1 and C4, and vehicles C2 and C3. The state information at the time T1 includes vehicles C5 and C6, and part of vehicles C7 and C8.

Then, the vehicle IDs and the vehicle models of the vehicles C5 to C8 are determined to be “001 and a vehicle model A,” “002 and a vehicle model D,” “003 and a vehicle model C,” and “004 and the vehicle model A,” respectively, in analysis of the state information at the time T1.

It is assumed that the vehicle C1 in the state information at the time T2 is a vehicle being the vehicle C5 in the state information at the time T1 having traveled leftward in the diagram along a road R2. It is assumed that the vehicle C2 in the state information at the time T2 is a vehicle not being included in the state information at the time T1 and having traveled leftward in the diagram along the road R2 from the time T1.

It is assumed that the vehicle C3 in the state information at the time T2 is a vehicle being the vehicle C6 in the state information at the time T1 having traveled rightward in the diagram along the road R2. It is assumed that the vehicle C4 in the state information at the time T2 is a vehicle being the vehicle C8 in the state information at the time T1 having been stopped.

It is assumed that the vehicle C7 in the state information at the time T1 is not included in the state information at the time T2 as a result of traveling rightward in the diagram along the road R2 from the time T1.

In such a case, the vehicle C1 and the vehicle C5 are common vehicles, the vehicle C3 and the vehicle C6 are common vehicles, and the vehicle C4 and the vehicle C8 are common vehicles. Therefore, the vehicle type analysis unit 111 sets the vehicle ID of each of the vehicles C1, C3, and C4 in the state information at the time T2 to the same vehicle ID as that assigned in the analysis of the state information at the time T1.

Specifically, the vehicle type analysis unit 111 assigns “001” to the vehicle ID of the vehicle C1 and determines the vehicle model of the vehicle C1 to be the “vehicle model A” in analysis of the state information at the time T2.

The vehicle type analysis unit 111 assigns “002” to the vehicle ID of the vehicle C3 and determines the vehicle model of the vehicle C1 to be the “vehicle model D” in the analysis of the state information at the time T2. The vehicle type analysis unit 111 assigns “004” to the vehicle ID of the vehicle C4 and determines the vehicle model of the vehicle C1 to be the “vehicle model A” in the analysis of the state information at the time T2. Note that the vehicle model of a common vehicle may not be determined again for the state information at the time T2, and the vehicle model determined in the analysis of the state information at the time T1 may be employed as-is.

Further, the vehicle type analysis unit 111 assigns “005” being a new sign to the vehicle ID of the vehicle C2 and determines the vehicle model thereof in the analysis of the state information at the time T2. An example of the vehicle model of the vehicle C2 being a vehicle model B″ is illustrated in the diagram.

While an example of a vehicle tracking technique of tracking identical vehicles and assigning a vehicle ID to each vehicle has been described, various generally known technologies may be applied to the vehicle tracking technique without being limited to the above.

FIG. 8 is referred to again.

Based on the vehicle model of each of the one or more vehicles C determined in Step S101a, the vehicle type analysis unit 111 determines the vehicle type of each of the one or more vehicles C (Step S101b).

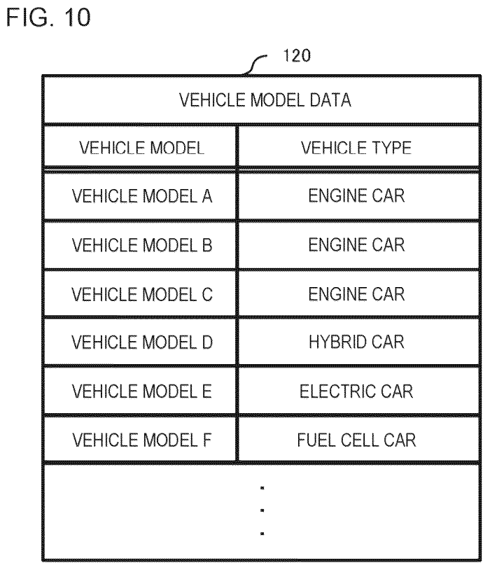

For example, vehicle model data 120 previously held in the vehicle type analysis unit 111 are used in the determination of the vehicle type in Step S101b. The vehicle model data 120 are data in which a vehicle model and a vehicle type are associated with each other. FIG. 10 illustrates an example of the vehicle model data 120.

By referring to the vehicle model data 120, the vehicle type analysis unit 111 determines a vehicle type related to the vehicle model of a determined vehicle C. Thus, the vehicle type of each of one or more vehicles C traveling on a road R in a surveilled region P can be determined based on state information.

Note that the method for determining the vehicle type of each of one or more vehicles C traveling on a road R in a surveilled region P is not limited to the above, and for example, the vehicle type may be determined directly from state information by using a learning model trained by machine learning. In this case, by inputting the latest and past state information (image information) to a trained vehicle type determination model undergoing machine learning for determining a vehicle type, information in which the vehicle ID of each of the one or more vehicles C traveling on the road R in the surveilled region P and the vehicle model are associated with each other is output. Input data to the vehicle type determination model and training data during learning may be similar to input data and training data during learning of the vehicle model determination model.

FIG. 8 is referred to again.

The analysis result generation unit 112 generates an analysis result, based on the processing results in Step S101a and S101b (Step S101c).

As described with reference to FIG. 4, a region ID, time information, a vehicle ID, and a vehicle type are associated with each other in an analysis result according to the present example embodiment. The region ID and the time included in the analysis result are the same region ID and time information as those included in state information being a basis of generation of the analysis result.

The vehicle ID and the vehicle type that are included in the analysis result are a vehicle ID and a vehicle type that are related to each of one or more vehicles C included in the state information being the basis of generation of the analysis result. The vehicle ID assigned in Step S101a and the vehicle type determined in S101b for a vehicle C identified by the vehicle ID are associated with each other in the analysis result.

The analysis result generation unit 112 stores the analysis result generated in Step S101c into the storage unit 107 (Step S101d).

FIG. 7 is referred to again.

The emission evaluation unit 104 finds an estimated value of an amount of CO₂ emission accompanying travel of the one or more vehicles in each surveilled region P by using an evaluation model with the analysis result generated in Step S101c as input data. Thus, the emission evaluation unit 104 evaluates an amount of greenhouse gas emission accompanying travel of the one or more vehicles in each surveilled region P. Then, the emission evaluation unit 104 generates evaluation information including the estimated value of an amount of CO₂ emission being the evaluation result (Step S102).

### Example 1 of Evaluation Model

The evaluation model according to the present example embodiment includes a plurality of models for each vehicle type and is a model based on an assumption that an amount of CO₂ emission per vehicle is constant for each vehicle type. For example, an amount of CO₂ emission per vehicle for each vehicle type is an amount of CO₂ emission during average travel for each vehicle type and may be experimentally acquired based on a sensor (such as a flow sensor or a CO₂ sensor) attached to a vehicle C or may be a value determined with reference to a value appearing in a catalog of the vehicle C, or the like.

Examples of such an evaluation model include Equation (1).

$$\begin{matrix}[ Math . 1 ] & \\ Evaluation value H = \sum {G}_{i} = \sum K ( {M}_{i} ) \times {TL}_{i} & Equation ( 1 )\end{matrix}$$

An evaluation value H represents an evaluation value of an amount of CO₂ emission accompanying travel of all vehicles C in a surveilled region P and as described above, is an estimated value of the amount, according to the present example embodiment.

Gᵢ denotes an evaluation value of an amount of CO₂ emission from a vehicle Cᵢ and is an estimated value of the amount of CO₂ emission from the vehicle Cᵢ, according to the present example embodiment. Note that, assuming that the total number of vehicles C included in the latest state information of the surveilled region P is N (where N is an integer equal to or greater than 1), the vehicle Cᵢ represents an i-th vehicle C (where i is an integer equal to or greater than 1 and equal to or less than N).

Mᵢ represents the vehicle type of the vehicle Cᵢ.

K(X) denotes an emission factor for a vehicle type X and for example, denotes a per-unit-time amount of CO₂ emission from a vehicle C with the vehicle type X. As described above, K(X) is a constant determined for each vehicle type X, according to the present example embodiment.

TLᵢ represents the length of time for which the vehicle Cᵢ exists in the surveilled region P and is a time interval for acquisition of state information by the information acquisition unit 110, according to the present example embodiment.

Note that, for example, when time intervals at which analysis by the analysis unit 103 is executed are somewhat long, TLᵢ may be a length of time required for the vehicle Cᵢ to pass through the surveilled region P. An analysis result according to the present example embodiment enables determination of a vehicle C existing at each time in each surveilled region P and the vehicle type of the vehicle, and therefore TLᵢ can be found from the difference between a time at which a vehicle C enters each surveilled region P and a time at which the vehicle exits the region.

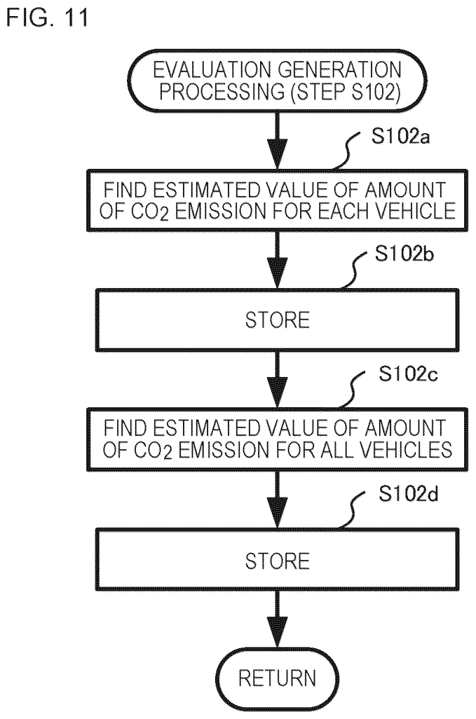

FIG. 11 illustrates an example of a flowchart of evaluation generation processing (Step S102). As illustrated in the diagram, by using the evaluation model, the first evaluation unit 117 finds an estimated value of an amount of CO₂ emission for each of the one or more vehicles C traveling on a road R in a surveilled region P (Step S102a).

In Step S102a, the first evaluation unit 117 finds a value of Gᵢ in Equation (1) as an estimated value of an amount of CO₂ emission for each of the one or more vehicles C traveling on the road R in the surveilled region P. Specifically, the first evaluation unit 117 finds an estimated value of an amount of greenhouse gas emission accompanying travel of each of the one or more vehicles C included in an analysis result by using a model based on the vehicle type of each of the one or more vehicles C with the analysis result as input data.

The first evaluation unit 117 generates first evaluation information including the estimated value of each vehicle C found in Step S102a and stores the information into the storage unit 107 (Step S102b).

For example, the first evaluation information generated in Step S102b is information in which a region ID, time information, a vehicle ID, and an estimated value as an evaluation value are associated with each other. The region ID and the time information are the same region ID and time information as those included in state information being a processing target. The vehicle ID is a vehicle ID of each vehicle C included in the state information being the processing target. The estimated value is an estimated value for a vehicle C identified by an associated vehicle ID [that is, Gᵢ in Equation (1)].

The second evaluation unit 118 finds an estimated value of an amount of CO₂ emission for all of the one or more vehicles traveling on the road R in the surveilled region P by finding the total sum of estimated values of amounts of CO₂ emission found for the respective vehicles C in Step S102a (Step S102c).

In Step S102c, the second evaluation unit 118 finds a value of the evaluation value H in Equation (1) as an estimated value of an amount of CO₂ emission for all of the one or more vehicles traveling on the road R in the surveilled region P.

The second evaluation unit 118 generates second evaluation information including the estimated value of all the vehicles found in Step S102c and stores the information into the storage unit 107 (Step S102d).

For example, the second evaluation information generated in Step S102d is information in which a region ID, time information, and an estimated value as an evaluation value are associated with each other. The region ID and the time information are the same region ID and time information as those included in the state information being the processing target. The vehicle ID is a vehicle ID of each vehicle C included in the state information being the processing target. The estimated value is the total sum of the estimated values found in Step S102a [that is, H in Equation (1)].

FIG. 7 is referred to again.

The display control unit 105 generates display information including an evaluation map, based on the evaluation information generated in Step S102 (Step S103), and ends the evaluation processing. The display control unit 105 outputs the display information generated in Step S103 to the display unit 106. Thus, the display unit 106 displays the display information.

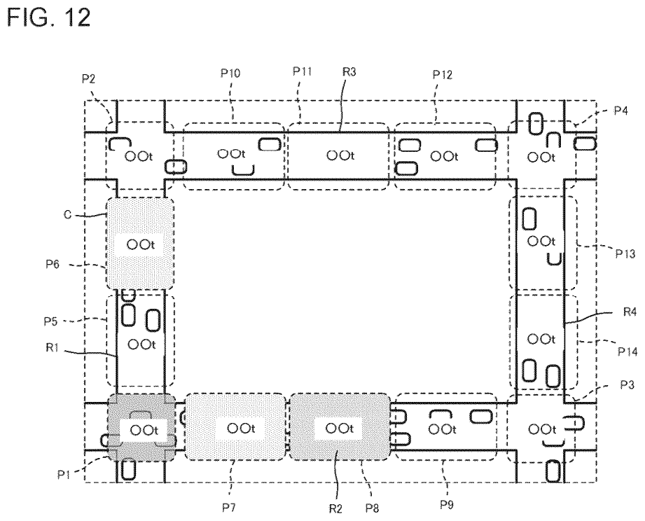

An evaluation map indicates a result of evaluation by the emission evaluation unit 104 (such as estimated values included in evaluation information or the totalized value thereof) on a map. FIGS. 12 to 14 illustrate examples of an evaluation map.

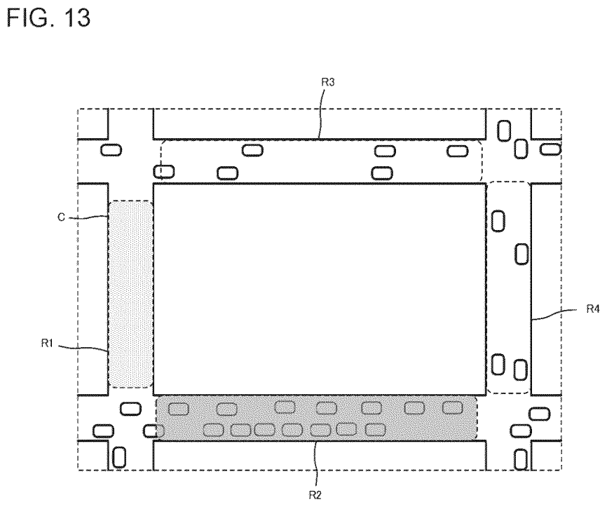

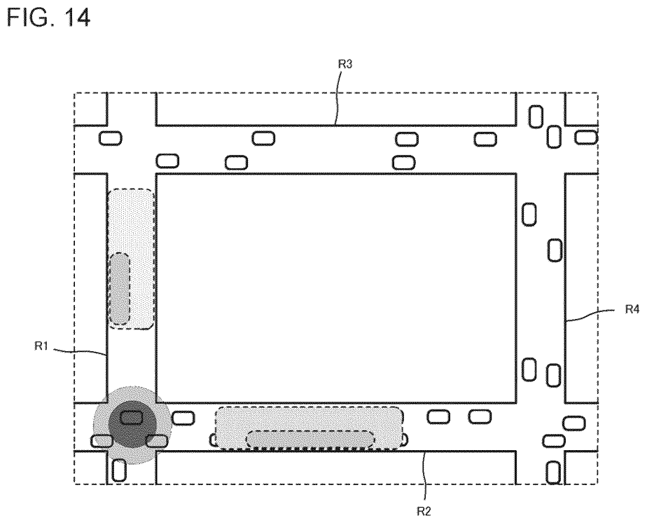

FIG. 12 is an example of an evaluation map indicating an evaluation value [represented by weight (ton)] in each surveilled region P and the surveilled region P by dots with density based on the magnitude of the value on a map. FIG. 13 is an example of an evaluation map indicating an evaluation value for each road by dots with density based on the magnitude of the value on a map. FIG. 14 is an example of an evaluation map indicating a distribution of evaluation values in an entire region including a plurality of surveilled regions P1 to P14 (an area) by dots with density based on the magnitude of the distribution on a map.

FIGS. 12 to 14 illustrate examples using dots with density based on the magnitude of an evaluation value, and the density of dots increases as the evaluation value increases. Note that color-coding or the like based on the magnitude of an evaluation value may be used in an evaluation map.

An evaluation map is not limited to the above and may be appropriately changed. Further, an evaluation map to be displayed may be previously determined or may be determined in accordance with user specification immediately before Step S103. Status of an amount of CO₂ emission can be easily recognized on a map by referring to an evaluation map. In particular, by using with the evaluation information generated in Step S102 in real time, status of a current amount of CO₂ emission can be easily recognized in real time.

The first example embodiment has been described above.

According to the present example embodiment, an analysis result including the vehicle types of one or more vehicles traveling on a road R is generated by analyzing state information indicating states of the one or more vehicles C. Then, an amount of greenhouse gas emission accompanying travel of the one or more vehicles is evaluated by using an evaluation model for evaluating an amount of greenhouse gas emission accompanying travel of a vehicle C with the analysis result as input data.

Since analysis of state information can be executed in real aime, an analysis result can be acquired in real time. Further, since an evaluation model is previously determined, an amount of greenhouse gas emission accompanying travel of a vehicle may also be evaluated in real time by using an analysis result and an evaluation model. Accordingly, real-time performance related to evaluation of an amount of greenhouse gas emission on a road R can be improved.

According to the present example embodiment, an evaluation model includes a model for each vehicle type. Then, an amount of greenhouse gas emission accompanying travel of each of one or more vehicles C is evaluated by using a model based on the vehicle type of each of the one or more vehicles included in an analysis result with the analysis result as input data. Thus, an evaluation value of an amount of greenhouse gas emission accompanying travel of each vehicle C can be easily acquired. Accordingly, real-time performance related to evaluation of an amount of greenhouse gas emission from each vehicle C on a road R can be improved.

According to the present example embodiment, an amount of greenhouse gas emission accompanying travel of one or more vehicles C is evaluated by finding the total sum of evaluation values of respective amounts of greenhouse gas emission accompanying travel of the vehicles C. Thus, an evaluation value of an amount of greenhouse gas emission from all vehicles traveling on a road R can be easily acquired. Accordingly, real-time performance related to evaluation of an amount of greenhouse gas emission from all vehicles on the road R can be improved.

According to the present example embodiment, a result of evaluation of an amount of greenhouse gas emission accompanying travel of a vehicle C can be displayed on the display unit 106 in real time. Accordingly, a user can recognize the evaluation of an amount of CO₂ emission on a road in real time and for example, can take a countermeasure for reducing the amount of CO₂ emission.

### Modified Example 1: Another Example of Display Information

While an example of display information including an evaluation map has been described in the first example embodiment, a result of evaluation by the emission evaluation unit 104 may be displayed by another method.

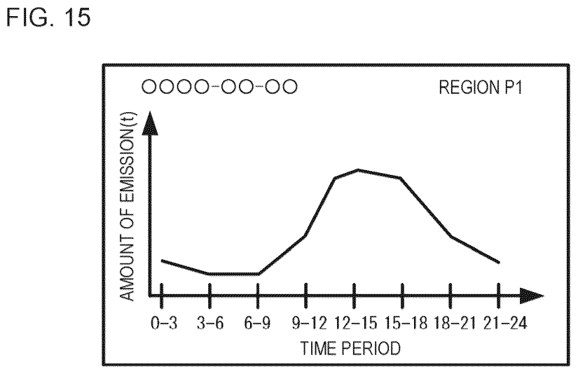

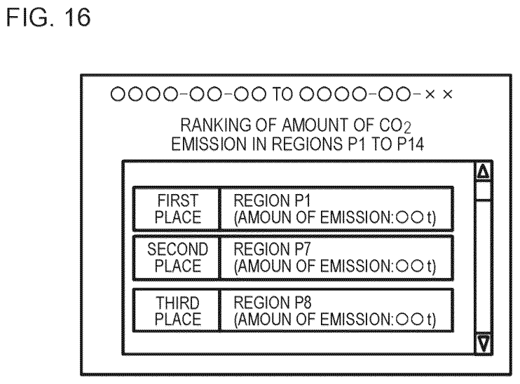

For example, display information may include a graph as illustrated in FIG. 15 or ranking as illustrated in FIG. 16. FIG. 15 illustrates an example of displaying a graph illustrating changes in an amount of CO₂ emission in a surveilled region P1 for each time period. FIG. 16 illustrates an example of displaying ranking of amounts of CO₂ emission in a plurality of surveilled regions P1 to P14.

Further, for example, while not being illustrated, display information may include a graph illustrating changes in amounts of CO₂ emission in a plurality of surveilled regions P1 to P14 for each time period. By display of such a graph, amounts of CO₂ emission can be easily compared between time periods in each surveilled region P.

Furthermore, for example, display information may include either item out of first evaluation information including an estimated value for each vehicle C found by the first evaluation unit 117 and second evaluation information including an estimated value of an amount of CO₂ emission for all vehicles found by the second evaluation unit 118 or may include both.

### Second Example Embodiment

An example of evaluating an amount of greenhouse gas emission accompanying travel of a vehicle C in surveilled regions P1 to P14 by using a travel state such as travel velocity or acceleration of the vehicle C traveling on a road R in a surveilled region P in addition to the vehicle type of the vehicle C will be described in a second example embodiment. For simplification of description, points different from the first example embodiment will be mainly described in the present example embodiment.

An evaluation system 200 according to the present example embodiment is a system for evaluating an amount of greenhouse gas emission accompanying travel of a vehicle C in surveilled regions P1 to P14, similarly to the first example embodiment. A case of greenhouse gas an amount of emission of which to be evaluated by the evaluation system 200 being CO₂ and an evaluation value of the amount of emission being an estimated amount of the amount of emission will be described as an example in the present example embodiment as well.

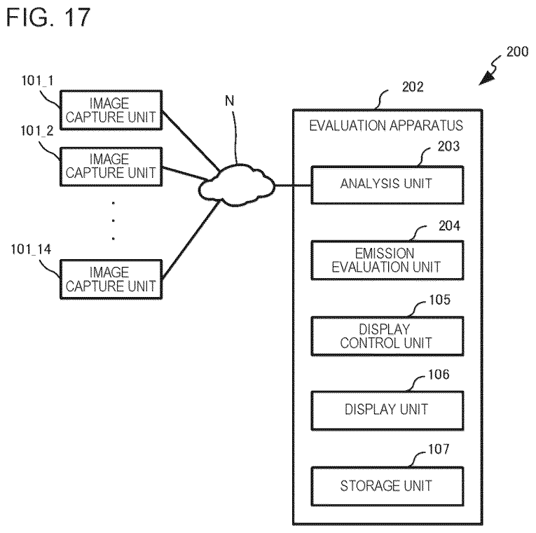

As illustrated in FIG. 17, the evaluation system 200 includes image capture units 101_1 to 101_14 similar to those according to the first example embodiment and an evaluation apparatus 202 replacing the evaluation apparatus 102 according to the first example embodiment.

### <Functional Configuration of Greenhouse Gas Emission Evaluation Apparatus (Evaluation Apparatus) 202>

As illustrated in FIG. 17, the evaluation apparatus 202 according to the present example embodiment functionally includes an analysis unit 203 and an emission evaluation unit 204 replacing the analysis unit 103 and the emission evaluation unit 104 according to the first example embodiment. Except for the above, the evaluation apparatus 202 is preferably configured similarly to the evaluation apparatus 102 according to the first example embodiment.

When acquiring state information of a surveilled region P from an image capture unit 101 in real time, the analysis unit 203 generates an analysis result in real time by analyzing the acquired state information and stores the generated analysis result into a storage unit 107, similarly to the first example embodiment.

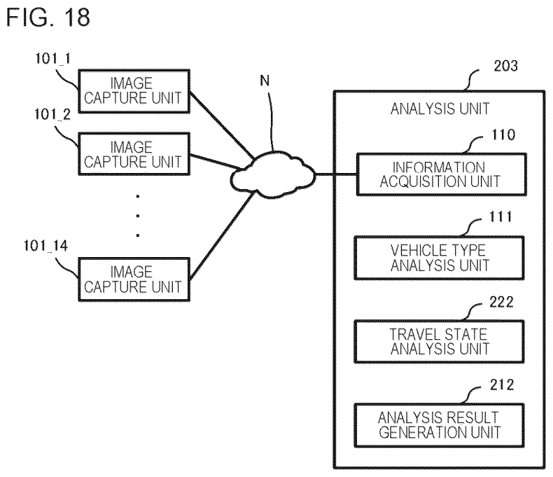

Specifically, as illustrated in FIG. 18, the analysis unit 203 functionally includes an information acquisition unit 110 and a vehicle type analysis unit 111 similar to those according to the first example embodiment, and an analysis result generation unit 212 replacing the analysis result generation unit 112. The analysis unit 203 further includes a travel state analysis unit 222.

The travel state analysis unit 222 acquires a travel state of each of one or more vehicles C traveling on a road R in a surveilled region P by analyzing state information acquired by the information acquisition unit 110.

A travel state includes travel velocity, acceleration (a rate of change of travel velocity), an idling-stop state, and a loaded amount. Travel velocity includes a case of a vehicle C being stopped, that is, being zero. A loaded amount is typically the total weight of a person on board a vehicle C and baggage loaded on the vehicle C but may be the weight of baggage loaded on the vehicle C or the weight of a person on board the vehicle C.

Note that a travel state has only to include at least one item out of travel velocity, acceleration, an idling-stop state, and a loaded amount.

The analysis result generation unit 212 generates an analysis result including a vehicle type determined by the vehicle type analysis unit 111 and a travel state acquired by the travel state analysis unit 222. The analysis result generation unit 212 stores the analysis result into the storage unit 107.

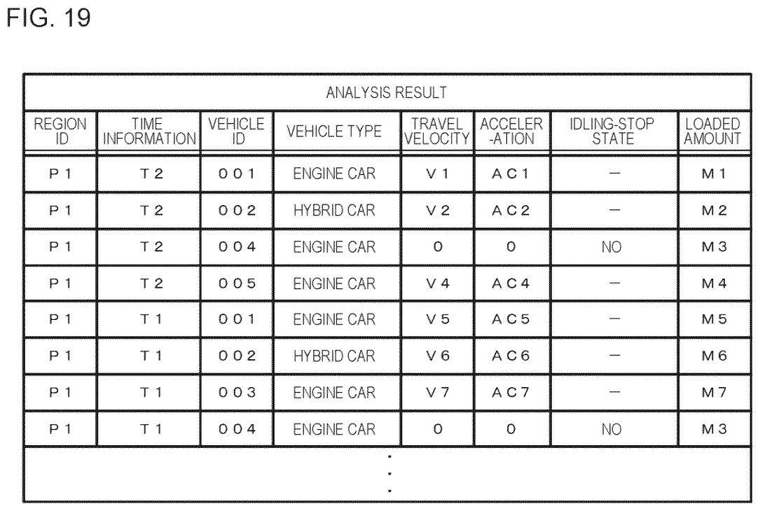

FIG. 19 illustrates an example of an analysis result generated by the analysis result generation unit 212 according to the present example embodiment. Travel velocity, acceleration, an idling-stop state, and a loaded amount in addition to a region ID, time information, a vehicle ID, and a vehicle type similar to those according to the first example embodiment (see FIG. 4) are associated with each other in an analysis result according to the present example embodiment.

Travel velocity, acceleration, an idling-stop state, and a loaded amount that are included in an analysis result are travel velocity (for example, in units of km/h), acceleration (for example in units of km/h), an idling-stop state, and a loaded amount (kg) of a vehicle C identified by an associated vehicle ID. Note that km represents kilometer, h represents time, and kg represents kilogram.

Since a vehicle C with a vehicle ID “004” is being stopped (see FIG. 9), both the travel velocity and the acceleration of the vehicle are zero.

An idling-stop state indicates whether a stopped vehicle is in an idling-stop state. Since the vehicle C with the vehicle ID “004” is the only stopped vehicle C out of vehicles C with vehicle IDs “001” to “005,” a value is set only to the idling-stop state associated with the vehicle ID “004.” The example in FIG. 19 indicates that the vehicle C with the vehicle ID “004” is not in the idling-stop state.

FIG. 17 is referred to again.

The emission evaluation unit 204 evaluates an amount of greenhouse gas emission accompanying travel of one or more vehicles C traveling on a road R in a surveilled region P by using a previously prepared evaluation model, generates evaluation information including the result of the evaluation, and stores the evaluation information into the storage unit 107, similarly to the first example embodiment.

The evaluation model according to the present example embodiment differs from the evaluation model according to the first example embodiment in using an analysis result generated by the analysis result generation unit 212 as input data. In other words, the evaluation model according to the present example embodiment uses an analysis result including a travel state in addition to an analysis result similar to that according to the first example embodiment as input data. Except for this point, the evaluation model according to the present example embodiment is similar to the evaluation model according to the first example embodiment.

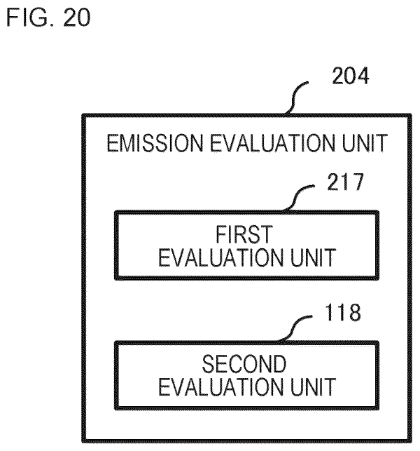

Specifically, for example, the emission evaluation unit 204 includes a first evaluation unit 217 replacing the first evaluation unit 117 according to the first example embodiment and a second evaluation unit 118 similar to that according to the first example embodiment, as illustrated in FIG. 20.

The first evaluation unit 217 evaluates evaluation of an amount of CO₂ emission accompanying travel of each of one or more vehicles C traveling on a road R in a surveilled region P, by using an evaluation model different from that according to the first example embodiment.

The first evaluation unit 217 differs from the first evaluation unit 117 according to the first example embodiment in using an analysis result generated by the analysis result generation unit 212 as input data to the evaluation model. Except for this point, the first evaluation unit 217 according to the present example embodiment is similar to the first evaluation unit 117 according to the first example embodiment.

### <Physical Configuration of Greenhouse Gas Emission Evaluation Apparatus (Evaluation Apparatus) 202>

It is preferable that the evaluation apparatus 202 according to the present example embodiment be physically configured similarly to the evaluation apparatus 102 according to the first example embodiment.

### <Operation of Greenhouse Gas Emission Evaluation System (Evaluation System) 200>

The operation of the evaluation system 200 will be described below.

The operation of each image capture unit 101 is similar to that of the first example embodiment. Evaluation processing according to the present example embodiment is repeatedly executed for each of the surveilled regions P1 to P14 with state information (that is, the latest state information) as a processing target every time the information acquisition unit 110 acquires state information from an image capture unit 101, similarly to the first example embodiment.

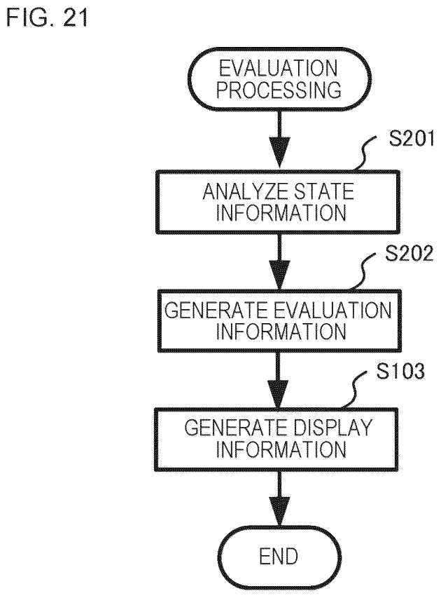

FIG. 21 illustrates an example of a flowchart of the evaluation processing according to the present example embodiment.

As illustrated in the diagram, when acquiring state information, the analysis unit 203 analyzes the acquired latest state information (Step S201).

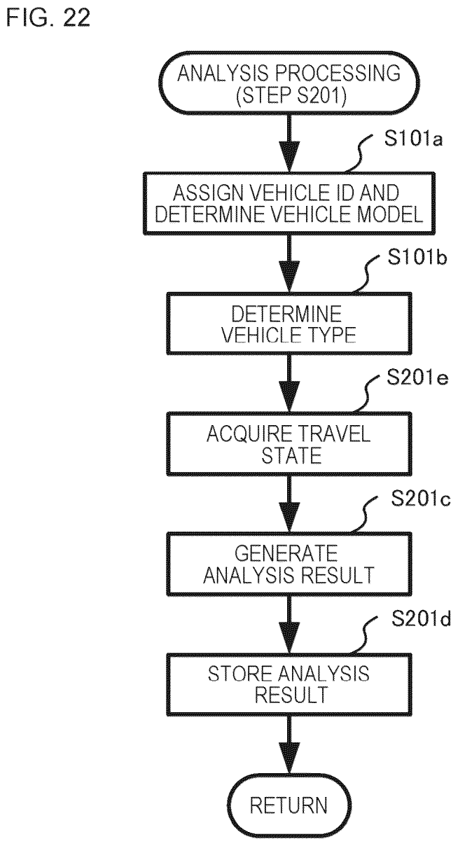

FIG. 22 illustrates an example of a flowchart of analysis processing (Step S201). As illustrated in the diagram, Step S201e is executed subsequently to Steps S101a and S101b similar to those in the first example embodiment.

The travel state analysis unit 222 acquires a travel state of each of one or more vehicles C traveling on a road R in a surveilled region P by analyzing the state information acquired by the information acquisition unit 110 (Step S201e).

Travel velocity is found based on pieces of state information at a time T1 and a time T2. Specifically, travel velocity is found from a time period from the time T1 to the time T2, and the distance traveled by the vehicle C during the time period. For example, the distance traveled by the vehicle C is found by converting the positions of the vehicle C in images included in the pieces of state information at the time T1 and the time T2 into an actual distance.

Acceleration is found as an amount of change per unit time between two velocities being the velocity of a vehicle C found from the time T1 and the time T2, and the velocity of the vehicle C found from pieces of state information at the time T1 and a time T3. The state information at the time T3 is state information related to status of a surveilled region P preceding the state information at the time T1 by a predetermined time and for example, is state information generated immediately before the state information at the time T1. A method for finding the velocity of the vehicle C from the pieces of state information at the time T1 and the time T3 may be similar to the method for finding the velocity of the vehicle C from the pieces of state information at the time T1 and the time T2.

For example, an idling-stop state is determined by comparing the vibration of a vehicle C with a predetermined threshold value. The vibration of the vehicle C is found based on the latest state information and preceding state information. For example, when the vibration of the vehicle C is equal to or greater than the threshold value, the vehicle C is determined to be not in an idling-stop state, and when the vibration of the vehicle C is less than the threshold value, the vehicle C is determined to be in an idling-stop state.

For example, a loaded amount is found based on an amount of depression of a vehicle C. The amount of depression of the vehicle C is found by comparing the height of the vehicle C acquired by analyzing an image with a standard height of a vehicle being the same vehicle model as that of the vehicle C.

The analysis result generation unit 212 generates an analysis result, based on the processing results in Steps S101a, S101b, and S201e (Step S201c).

As described with reference to FIG. 19, a region ID, time information, a vehicle ID, and a vehicle type similar to those according to the first example embodiment, and a travel state (travel velocity, acceleration, an idling-stop state, and a loaded amount) are associated with each other in an analysis result according to the present example embodiment. A travel state included in an analysis result is a travel state acquired in Step S201e for a vehicle C identified by a vehicle ID associated with the travel state.

The analysis result generation unit 212 stores the analysis result generated in Step S201c into the storage unit 107 (Step S201d).

FIG. 21 is referred to again.

The emission evaluation unit 204 finds an estimated value of an amount of CO₂ emission accompanying travel of the one or more vehicles in each surveilled region P by using the evaluation model with the analysis result generated in Step S201c as input data. Thus, the emission evaluation unit 204 evaluates the amount of greenhouse gas emission accompanying travel of the one or more vehicles in each surveilled region P. Then, the emission evaluation unit 204 generates evaluation information including an estimated value of an amount of CO₂ emission being the evaluated result (Step S202).

### (Example 2 of Evaluation Model)

The evaluation model according to the present example embodiment includes a plurality of models each of which is for each vehicle type and is a model representing an amount of CO₂ emission per vehicle by a function taking a travel state as a variable. For example, the function representing an amount of CO₂ emission per vehicle for each vehicle type is a function representing an amount of CO₂ emission of an average vehicle C for each vehicle type and may be experimentally acquired based on a sensor (such as a flow sensor or a CO₂ sensor) attached to the vehicle C or may be a function determined with reference to a value appearing in a catalog of the vehicle C, or the like.

Examples of such an evaluation model include Equation (2).

$$\begin{matrix}[ Math . 2 ] & \\ Evaluation value H = \sum {G}_{i} = \sum K ( {M}_{i} , {RS}_{i} ) \times {TL}_{i} & Equation ( 2 )\end{matrix}$$

An evaluation value H, Gᵢ, Mᵢ, and TLᵢ are respectively similar to those in Equation (1) in the first example embodiment.

RSᵢ represents a travel state and for example, is a vector quantity including values of travel velocity, acceleration, an idling-stop state, and a loaded amount as components.

For example, a predetermined value associated with whether a vehicle is idling is preferably set to a value of an idling-stop state. Specifically, for example, it is preferable that “1” be set to an idling state, and “0” be set to a non-idling state.

K(X, Y) is an emission factor for a vehicle type X and a travel state Y, and for example, is an amount of CO₂ emission per unit time of a vehicle C with the vehicle type X and the travel state Y. As described above, K(X, Y) according to the present example embodiment is a function determined for each vehicle type X and takes a travel state Y including travel velocity, acceleration, an idling-stop state, and a loaded amount as a variable.

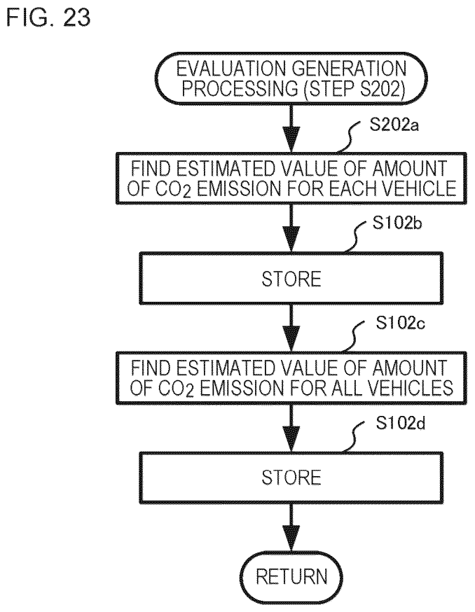

FIG. 23 illustrates an example of a flowchart of evaluation generation processing (Step S202). As illustrated in the diagram, Step S202a replacing Step S102a in the evaluation generation processing according to the first example embodiment (Step S102) is executed in the evaluation generation processing according to the present example embodiment (Step S202).

The first evaluation unit 217 finds an estimated value of an amount of CO₂ emission for each of the one or more vehicles C traveling on a road R in a surveilled region P, by using the evaluation model with an analysis result including a vehicle type and a travel state as input data (Step S202a).

In Step S202a, the first evaluation unit 217 finds a value of Gᵢ in Equation (2) as an estimated value of an amount of CO₂ emission for each of the one or more vehicles C traveling on the road R in the surveilled region P. In other words, the first evaluation unit 217 finds an estimated value of an amount of greenhouse gas emission accompanying travel of the one or more vehicles C by using a model based on the vehicle type of each of the one or more vehicles C included in the analysis result with the analysis result as input data.

Subsequently to Step S202a, Steps S102b to S102d similar to those in the first example embodiment are executed. FIG. 21 is referred to again; and Step S103 similar to the first example embodiment is executed, and the evaluation processing is ended.

The second example embodiment has been described above.

The present example embodiment also provides effects similar to those of the first example embodiment.

An analysis result according to the present example embodiment includes a travel state of a vehicle C in addition to the vehicle type. Thus, a travel state can be included in input data to the evaluation model. Accordingly, an amount of greenhouse gas emission from a vehicle C on a road R can be more accurately evaluated.

### Modified Example 2: Example 3 of Evaluation Model

An evaluation model may include a model evaluating an amount of greenhouse gas emission accompanying travel of a vehicle C by using at least one of a generation cost and a transportation cost of drive energy supplied to the vehicle C.

Examples of drive energy supplied to a vehicle C include gasoline in a gasoline car, light oil in a diesel car, electric power in an electric car, and hydrogen in a hydrogen car.

A generation cost of drive energy is a cost of generating the drive energy and for example, is a value converted into an amount of emission of the same type of greenhouse gas as that of greenhouse gas evaluated by the evaluation model (CO₂ in the second example embodiment).

For example, a generation cost of gasoline is an amount of greenhouse gas emission emitted for manufacturing gasoline. The same holds for a generation cost of each of light oil and hydrogen.

For example, a generation cost of electric power is an amount of greenhouse gas emission emitted for generating the electric power. Specifically, for example, a generation cost of electric power may be a predetermined fixed value per unit power. Further, for example, when vehicle information includes information indicating a power feeding station where a vehicle is fed with power, and a generation cost of electric power per unit power at the power feeding station can be acquired from an external apparatus (unillustrated) or the like, the generation cost of electric power may be the generation cost per unit power at the power feeding station where the vehicle C is fed with power.

A transportation cost of drive energy is a cost for transporting the drive energy and is a value converted into an amount of greenhouse gas emission of the same type as that of greenhouse gas evaluated by the evaluation model.

For example, a transportation cost of gasoline is an amount of greenhouse gas emission emitted for transporting gasoline. Specifically, for example, a transportation cost of gasoline may be a predetermined fixed value per unit quantity. Further, for example, when vehicle information includes information indicating a gasoline station where a vehicle is filled with gasoline, and a transportation cost per unit quantity at the gasoline station can be acquired from an external apparatus (unillustrated) or the like, the transportation cost of gasoline may be the transportation cost per unit quantity at the gasoline station where the vehicle C is filled with gasoline. The same holds for a transportation cost of each of light oil and hydrogen.

For example, a transportation cost of electric power is a value representing a power transmission loss by an amount of greenhouse gas emission. Specifically, for example, a transportation cost of electric power may be a predetermined fixed value per unit power. Further, for example, when vehicle information includes information indicating a power feeding station where a vehicle is fed with power, and a transportation cost of electric power per unit power at the power feeding station can be acquired from an external apparatus (unillustrated) or the like, the transportation cost of electric power may be the transportation cost per unit power at the power feeding station where the vehicle C is fed with power.

Examples of an evaluation model performing evaluation by using a generation cost and a transportation cost of drive energy include Equation (3).

$$\begin{matrix}[ Math . 3 ] & \\ Evaluation value H = \sum {G}_{i} = \sum \{ K ( {M}_{i} , {RS}_{i} ) + GC ( {M}_{i} , {RS}_{i} ) + D C ( {M}_{i} , {RS}_{i} ) \} \times {TL}_{i} & Equation ( 3 )\end{matrix}$$

An evaluation value H, Gᵢ, Mᵢ, RSi, K(X, Y), and TLᵢ are respectively similar to those in Equation (2) in the second example embodiment.

GC(X, Y) is a generation cost coefficient for a vehicle type X and a travel state Y and for example, is a generation cost of drive energy consumed per unit time by a vehicle C with the vehicle type X and the travel state Y.

DC(X, Y) is a transportation cost coefficient for a vehicle type X and a travel state Y and for example, is a transportation cost of drive energy consumed per unit time by a vehicle C with the vehicle type X and the travel state Y.

Each of GC(X, Y) and DC(X, Y) is a function determined for each vehicle type X and takes a travel state Y including at least one item out of travel velocity, acceleration, an idling-stop state and a loaded amount as a variable.

When the evaluation model does not include a generation cost of drive energy, GC(Mᵢ, RSi) in Equation (3) is preferably deleted. Further, when the evaluation model does not include a transportation cost of drive energy, DC(Mᵢ, RSᵢ) in Equation (3) is preferably deleted.

The evaluation model according to this modified example includes a model evaluating an amount of greenhouse gas emission accompanying travel of a vehicle C by using either one or both of a generation cost and a transportation cost of drive energy supplied to the vehicle C. Thus, an amount of greenhouse gas emission accompanying travel of the vehicle C can be evaluated by using not only an amount of greenhouse gas emission from the vehicle C but also either one or both of the cost in generation of the drive energy and the cost in transportation of the drive energy. Accordingly, an amount of greenhouse gas emission from the vehicle C on a road R can be more accurately evaluated.

### Third Example Embodiment

An example of acquiring state information from an image capture unit 101 has been described in the first example embodiment. The present example embodiment will be described by an example of acquiring vehicle information generated by an on-vehicle apparatus equipped on a vehicle C as state information from the on-vehicle apparatus. For simplification of description, points different from the first example embodiment will be mainly described in the present example embodiment.

An evaluation system 300 according to the present example embodiment is a system for evaluating an amount of greenhouse gas emission accompanying travel of a vehicle C in surveilled regions P1 to P14, similarly to the first example embodiment. A case of greenhouse gas an amount of emission of which to be evaluated by the evaluation system 300 being CO₂ and an evaluation value of the amount of emission being an estimated amount of the amount of emission will be described as an example in the present example embodiment as well.

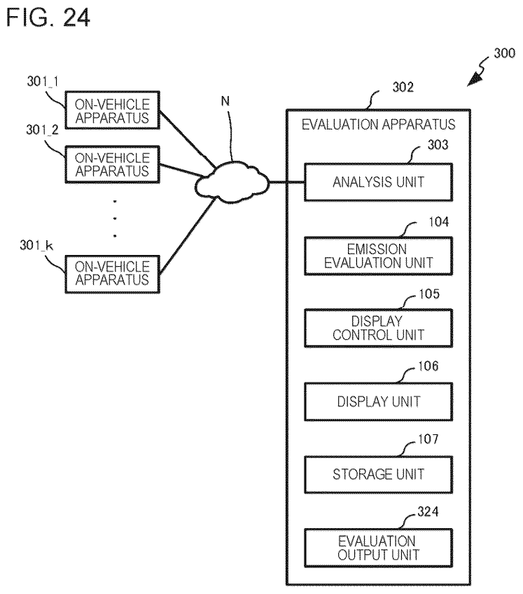

As illustrated in FIG. 24, the evaluation system 300 includes on-vehicle apparatuses 301_1 to 301_k and an evaluation apparatus 302. Note that k is an integer equal to or greater than 1.

Each of the on-vehicle apparatuses 301_1 to 301_k is an apparatus equipped on a vehicle C traveling on a road R and generates vehicle information about the vehicle C.

For example, vehicle information includes a vehicle model, a travel state, a vehicle number, an address of the on-vehicle apparatus in a network N, a current position, time information indicating the time of generation of the vehicle information, and the like.

A travel state included in vehicle information is similar to that according to the second example embodiment, and for example, acceleration is represented by a degree of openness of the accelerator. Further, for example, when a weight sensor is equipped on a vehicle C, a loaded amount is generated by the weight sensor.

For example, vehicle information is transmitted and received by intervehicular communication being communication between vehicles or communication between each of the on-vehicle apparatuses 301_1 to 301_k and an unillustrated roadside unit (RSU) placed on a road.

For example, vehicle information is transmitted vehicle information from an on-vehicle apparatus 301 or an RSU to the evaluation apparatus 302 through the network N at predetermined time intervals. Alternatively, for example, vehicle information is transmitted from an on-vehicle apparatus 301 or an RSU to the evaluation apparatus 302 through the network N in response to a request from the evaluation apparatus 302.

Unless being particularly distinguished from each other, the “on-vehicle apparatuses 301_1 to 301_k are hereinafter also expressed as “on-vehicle apparatuses 301.”

### <Functional Configuration of Greenhouse Gas Emission Evaluation Apparatus (Evaluation Apparatus) 302>

The evaluation apparatus 302 according to the present example embodiment functionally includes an analysis unit 303 replacing the analysis unit 103 according to the first example embodiment, as illustrated in FIG. 24. The evaluation apparatus 302 further includes a vehicle evaluation output unit 324. Except for the above, the evaluation apparatus 302 is preferably configured similarly to the evaluation apparatus 102 according to the first example embodiment.

When acquiring vehicle information generated by an on-vehicle apparatus 301 equipped on a vehicle C traveling on a road R in a surveilled region P as state information in real time, the analysis unit 303 holds the acquired state information. The analysis unit 303 analyzes vehicle information generated after the previous analysis as state information at predetermined time intervals. Thus, the analysis unit 303 generates an analysis result in real time. The analysis unit 303 stores the generated analysis result into a storage unit 107.

While the time intervals at which analysis processing is executed may be appropriately determined, the interval is desirably a relatively short time and, for example, may be 1/30 seconds similarly to the first example embodiment or 1 second to several seconds. The time intervals at which the analysis processing is executed may be changed according to conges status of the road R.

An analysis result is information acquired by analyzing state information, similarly to the first example embodiment, and at least includes vehicle types of one or more vehicles C included in the state information.

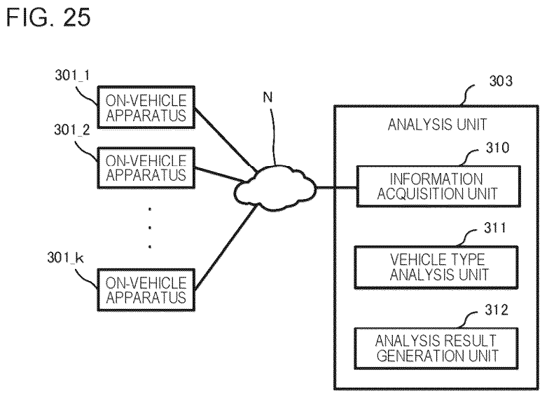

Specifically, the analysis unit 303 functionally includes an information acquisition unit 310, a vehicle type analysis unit 311, and an analysis result generation unit 312, as illustrated in FIG. 25.

The information acquisition unit 310 acquires vehicle information as state information through the network N and holds the acquired state information.

The vehicle type analysis unit 311 determines the vehicle type of each of one or more vehicles C traveling on a road R in a surveilled region P by analyzing state information acquired by the information acquisition unit 110.

Specifically, for example, the vehicle type analysis unit 311 determines the region ID of a surveilled region P in which a vehicle C related to vehicle information exists, based on the current position included in the vehicle information. “A vehicle C related to vehicle information” means a vehicle C equipped with an on-vehicle apparatus 301 generating the vehicle information.

The vehicle type analysis unit 311 extracts time information included in vehicle information.

The vehicle type analysis unit 311 assigns a vehicle ID to each vehicle number included in vehicle information. Note that a vehicle number included in vehicle information may be employed as a vehicle ID.

The vehicle type analysis unit 311 determines the vehicle type of a vehicle C related to vehicle information, based on a vehicle model included in the vehicle information, and vehicle model data 120. Note that when a vehicle type is included in vehicle information, the vehicle type analysis unit 311 determines the vehicle type of a vehicle C related to the vehicle information by extracting the vehicle type from the vehicle information.

Thus, the vehicle type analysis unit 311 according to the present example embodiment acquires a region ID, time information, a vehicle ID, and a vehicle type, based on vehicle information and the vehicle model data 120.

The analysis result generation unit 112 generates an analysis result including a vehicle type determined by the vehicle type analysis unit 111. The analysis result generation unit 112 stores the analysis result into the storage unit 107.

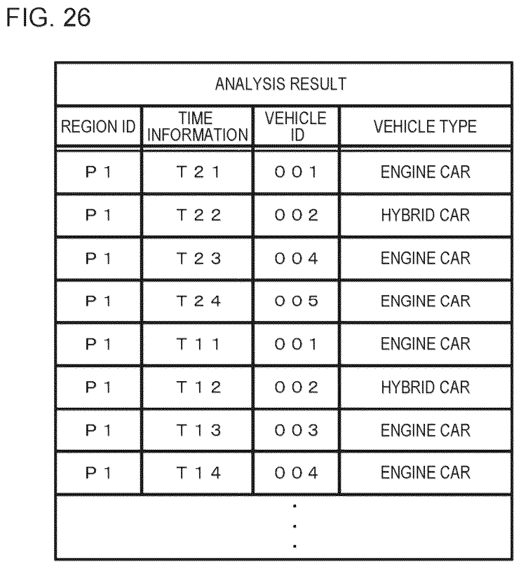

FIG. 26 illustrates an example of an analysis result generated by the analysis result generation unit 112 according to the present example embodiment. A region ID, time information, a vehicle ID, and a vehicle type in common with those in state information (on-vehicle information) being a basis of generation of an analysis result according to the present example embodiment are associated with each other also in the analysis result, similarly to an analysis result according to the first example embodiment.

According to the present example embodiment, a time at which on-vehicle information is generated often varies by on-vehicle apparatus 311. Therefore, the example of an analysis result illustrated in FIG. 26 differs from an analysis result according to the first example embodiment (see FIG. 4) in that pieces of time information included in the analysis result differ from each other. Note that it is a matter of course that pieces of on-vehicle apparatuses may be generated simultaneously in different on-vehicle apparatuses 311.

FIG. 24 is referred to again.

The evaluation output unit 324 transmits individual evaluation information including a result of evaluation for each vehicle C by the emission evaluation unit 104 to a related vehicle C.

Individual evaluation information is information indicating an evaluation related to an amount of CO₂ emission from a vehicle C being a destination. For example, individual evaluation information may be an estimated value related to a vehicle C being a destination in first evaluation information or may be an indicator such as characters and/or a symbol indicating the estimated value in steps (such as “large,” “normal,” or “small”).

### <Physical Configuration of Greenhouse Gas Emission Evaluation Apparatus (Evaluation Apparatus) 302>

It is preferable that the evaluation apparatus 302 according to the present example embodiment be physically configured similarly to the evaluation apparatus 102 according to the first example embodiment.

### <Operation of Greenhouse Gas Emission Evaluation System (Evaluation System) 300>

The operation of the evaluation system 300 will be described below.

As described above, when acquiring vehicle information as state information through the network N, the information acquisition unit 310 holds the acquired state information. The evaluation apparatus 102 executes emission evaluation processing (evaluation processing) for evaluating an amount of emission of greenhouse gas (CO₂ in the present example embodiment) accompanying travel of a vehicle C in a surveilled region P at predetermined time intervals. The evaluation processing is repeatedly executed for each of the surveilled regions P1 to P14 at the predetermined time intervals with each piece of vehicle information generated after the previous evaluation processing as a processing target.

An example of the evaluation processing executed at a time T2 will be described below. It is assumed that the time T2 is a time after an elapse of a predetermined time from a time T1 of execution of the previous evaluation processing and that analysis results at times T11, T12, T13, and T14 are generated and are used in evaluation of an amount of greenhouse gas emission in the evaluation processing executed at the time T1. It is further assumed that state information being a processing target of the evaluation processing executed at the time T2, that is, vehicle information generated after the time T1 before the time T2 includes pieces of vehicle information generated at times T21, T22, T23, and T24.

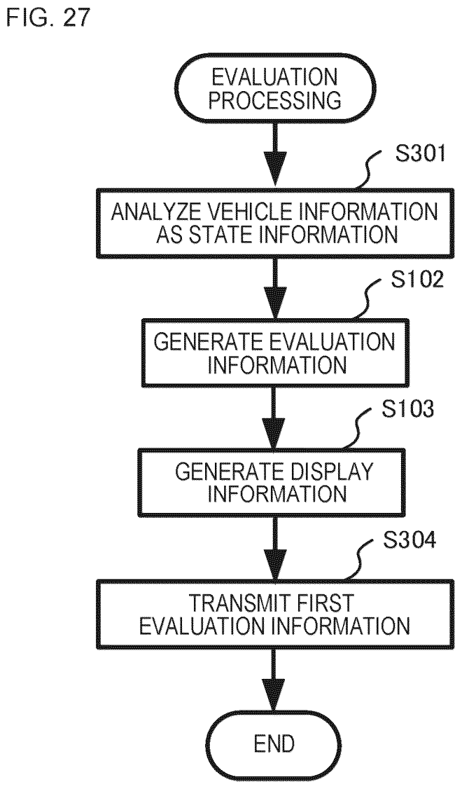

FIG. 27 illustrates an example of a flowchart of the evaluation processing according to the present example embodiment.

For example, when the predetermined time elapses from the time T1 of execution of the previous evaluation processing, the analysis unit 303 analyzes vehicle information as state information (Step S301). The vehicle information being a target of analysis in Step S301 includes each piece of vehicle information generated after the time T1 of execution of the previous evaluation processing.

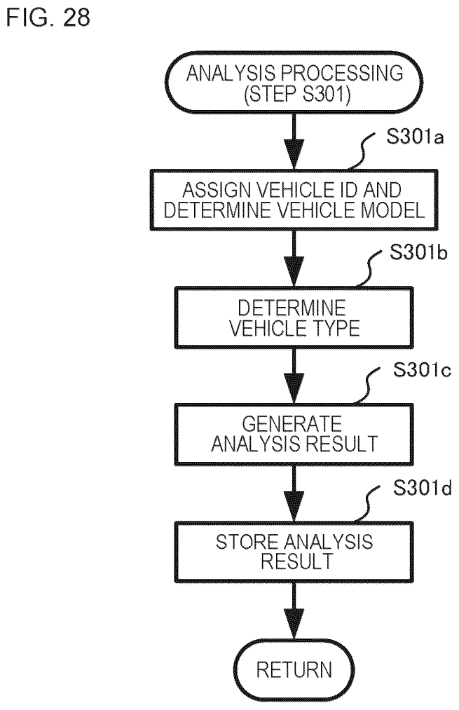

FIG. 28 illustrates an example of a flowchart of the analysis processing (Step S301). As illustrated in the diagram, when vehicle information as state information exists, the vehicle type analysis unit 311 assigns a vehicle ID to each of one or more vehicles C related to the vehicle information and determines a vehicle model of the vehicle C (Step S301a).

Specifically, the vehicle type analysis unit 311 determines the region ID of a surveilled region P in which the vehicle C related to the vehicle information exists, based on the current position included in the vehicle information. An example of vehicle information for which a determined region ID is “P1” being a target of the processing will be described below.

The vehicle type analysis unit 311 assigns a vehicle ID. At this time, the vehicle type analysis unit 311 refers to a vehicle number included in vehicle information and when a vehicle ID has been assigned to the vehicle number, assigns the same vehicle ID as the previously assigned vehicle ID.

The vehicle type analysis unit 311 determines a vehicle model included in the vehicle information.

The vehicle type analysis unit 311 according to the present example embodiment further extracts time information included in the vehicle information.

The vehicle type analysis unit 311 determines the vehicle type of each of the one or more vehicles C determined in Step S301a, based on the vehicle model of the vehicle C (Step S301b).

Specifically, for example, the vehicle type analysis unit 311 refers to the vehicle model data 120 illustrated in FIG. 10 and determines a vehicle type related to the vehicle model determined in Step S301b.

FIG. 28 is referred to again.

The analysis result generation unit 312 generates an analysis result, based on the processing results in Steps S301a and S301b (Step S301c).

As described with reference to FIG. 26, a region ID, time information, a vehicle ID, and a vehicle type are associated with each other in an analysis result according to the present example embodiment. A region ID and a time included in an analysis result are the same region ID and time information as those included in vehicle information as state information being a basis of generation of the analysis result.

A vehicle ID and a vehicle type included in an analysis result are a vehicle ID and a vehicle type related to a vehicle C included in vehicle information as state information being a basis of generation of the analysis result. A vehicle ID assigned in Step S301a and a vehicle type determined in S301b for a vehicle C identified by the vehicle ID are associated with each other in an analysis result.

The analysis result generation unit 312 stores the analysis result generated in Step S301c into the storage unit 107 (Step S301d).

FIG. 27 is referred to again.

Steps S102 and S103 similar to those in the first example embodiment are subsequently executed.

The evaluation output unit 324 generates, for each vehicle C, individual evaluation information including an estimated value for the vehicle C found in Step S102a as a result of evaluation and transmits the generated individual evaluation information to the related vehicle C (Step S304).

Specifically, for example, an estimated value found for a vehicle C with a vehicle ID “001” is transmitted to an on-vehicle apparatus 311 equipped on the vehicle C with the vehicle ID “001.” Further, for example, an estimated value found for a vehicle C with a vehicle ID “002” is transmitted to an on-vehicle apparatus 311 equipped on the vehicle C with the vehicle ID “002.” The same holds for other vehicles C. A destination is preferably determined by an address included in vehicle information.

Note that, for example, the evaluation output unit 324 may transmit, through the network N, generated individual evaluation information to a system or an apparatus (unillustrated) for surveilling an amount of greenhouse gas emission in a predetermined region.

By execution of Step S304, an estimated value being a result of evaluation related to an amount of CO₂ emission from a vehicle C can be displayed on display units in various apparatuses such as a car navigation system equipped on the vehicle C. Thus, an amount of CO₂ emission from a vehicle C can be notified to a driver, and the driver can be prompted to drive in such a way as to reduce the amount of CO₂ emission.

The third example embodiment has been described above.

The present example embodiment also provides effects similar to those of the first example embodiment.

### Modified Example 3

An example of employing an evaluation model similar to that according to the first example embodiment has been described in the third example embodiment. When travel information is included in vehicle information, the vehicle information may be analyzed as state information, and an analysis result similar to that according to the second example embodiment may be generated. Thus, an evaluation model similar to that according to the second example embodiment can be employed. Accordingly, an amount of greenhouse gas emission from a vehicle C on a road R can be more accurately evaluated, similarly to the second example embodiment.

### Modified Example 4

While examples of state information being image information have been described in the first and second example embodiments, and an example of state information being vehicle information has been described in the third example embodiment, state information may include both image information and state information. In other words, state information may include at least one item out of image information acquired by capturing an image of a road R and vehicle information about a vehicle traveling on the road R, the vehicle information being generated by an on-vehicle apparatus equipped on the vehicle.

For example, this modified example enables information difficult to be acquired from one item out of image information and vehicle information to be easily acquired from the other. Further, for example, information more accurate than that acquired from one item out of image information and vehicle information may be easily acquired from the other. For example, velocity information and acceleration information are often more easily and accurately acquired from vehicle information than from image information.

Thus, an amount of greenhouse gas emission from a vehicle C can be evaluated by using an evaluation model with a travel state including more information as input data. Accordingly, an amount of greenhouse gas emission from the vehicle C on a road R can be more accurately evaluated.

### Modified Example 5: Example 4 of Evaluation Model (Evaluation Model Using Travel Environment)

An example of an evaluation model including a travel state Y as a variable has been described in the second example embodiment. The evaluation model may include travel environment information being information about a travel environment of a road R as a variable in place of or in addition to the travel state Y. An example of an evaluation model including the travel state Y and a travel environment Z as variables will be described in this modified example.

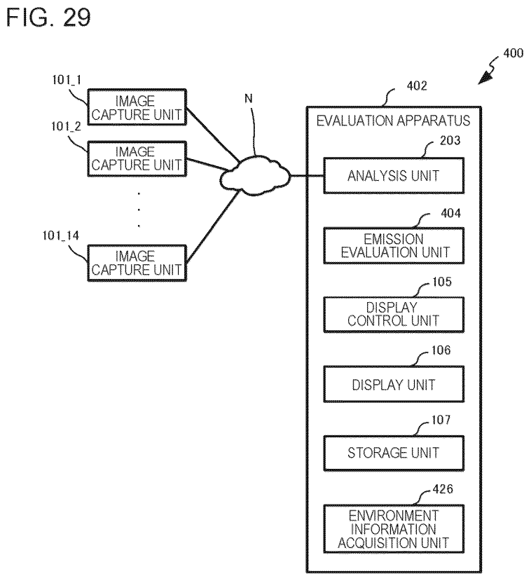

An evaluation system 400 according to a modified example 5 includes an evaluation apparatus 402 replacing the evaluation apparatus 202 according to the second example embodiment, as illustrated in FIG. 29. Except for this point, the evaluation system 400 may be configured similarly to the evaluation system 200 according to the second example embodiment.

The evaluation apparatus 402 according to this modified example includes an emission evaluation unit 404 replacing the emission evaluation unit 204 according to the second example embodiment. The evaluation apparatus 402 further includes an environment information acquisition unit 426. Except for these points, the evaluation apparatus 402 is preferably configured similarly to the evaluation apparatus 202 according to the second example embodiment.

The environment information acquisition unit 426 acquires travel environment information being information about a travel environment of a road R.

Travel environment information includes a factor affecting an amount of gas emission even when a vehicle C performs the same acceleration or deceleration or travels at the same vehicle velocity. Examples of travel environment information include road information, weather information, a road surface state, and a vehicle state (such as existence of chains attached to the tires of the vehicle C).

Note that travel environment information has only to include at least one item out of road information, weather information, a road surface state, and a vehicle state.

For example, road information is information indicating an attribute of a road R on which a vehicle C travels and is information indicating, for example, inclination, a curve, the number of lanes, a lane in which the vehicle C travels, and installation status of CO₂ absorbers in buildings and the like around the road. For example, installation status of CO₂ absorbers is represented by the number of buildings provided with CO₂ absorbers within a predetermined range from a surveilled region P or an area of a location where CO₂ absorbers are provided.

Road information is acquired based on image information generated by an image capture unit 101, and/or map information or topographical information of a surveilled region P. For example, a curve of a road R and the number of lanes are acquired by processing image information from an image capture unit 101 by using a conventional image processing technology. For example, the inclination of the road R and installation status of CO₂ absorbers in buildings and the like around the road are acquired based on map information or topographical information of the surveilled region P.

Weather information is information indicating wind force, precipitation, and the like. For example, wind force is acquired from an anemometer installed on a road R or an external apparatus (unillustrated) providing weather information. For example, precipitation is acquired from a pluviometer installed on a road R or an external apparatus (unillustrated) providing weather information.

Examples of a road surface state of a road R include existence of snow on the road surface, whether the road surface is wetted by rain or the like, and whether the road surface is frozen. For example, a road surface state is acquired by processing image information from an image capture unit 101 by using a conventional image processing technology.

For example, a vehicle state is existence of chains attached to the tires of a vehicle C. For example, a vehicle state is acquired by processing image information (state information) from an image capture unit 101 by using a conventional image processing technology.

Specifically, for example, a technology using pattern matching or a learning model trained by machine learning is preferably applied.

When a learning model trained by machine learning is used, a trained determination model undergoing machine learning for determining existence of chains attached to tires is used as the learning model. State information acquired by the information acquisition unit 110 is input to the determination model, and vehicle state information indicating whether chains are attached to the tires is output.

Input data to the determination model during learning are image information acquired by capturing an image of a road R. Supervised learning using training data including whether chains are attached to the tires of one or a plurality of vehicles C included in image information as a correct answer is preferably performed in machine learning.

Note that the environment information acquisition unit 426 may acquire travel environment information through input from a user.

While the emission evaluation unit 404 is mostly similar to the emission evaluation unit 204 according to the second example embodiment, an evaluation model employed for evaluating an amount of greenhouse gas emission accompanying travel of one or more vehicles C traveling on a road R in a surveilled region P differs from that according to the second example embodiment.

### Example 4 of Evaluation Model

The evaluation model according to the present example embodiment includes a plurality of models each of which is for each vehicle type and is a model representing an amount of CO₂ emission per vehicle by a function taking a travel state and a travel environment as variables. For example, the function representing an amount of CO₂ emission per vehicle for each vehicle type is a function representing an amount of CO₂ emission from an average vehicle C for each vehicle type, and the function may be experimentally acquired based on a sensor (such as a flow sensor detecting an amount of flow of emission gas or a CO₂ sensor detecting concentration of CO₂) attached to a vehicle C or may be a function determined with reference to a value appearing in a catalog of the vehicle C, or the like.

Examples of such an evaluation model include Equation (4).

$$\begin{matrix}[ Math . 4 ] & \\ Evaluation value H = \sum {G}_{i} = \sum K ( {M}_{i} , {RS}_{i} , {DE}_{i} ) \times {TL}_{i} & Equation ( 4 )\end{matrix}$$

An evaluation value H, Gᵢ, Mᵢ, RSᵢ, and TLᵢ are respectively similar to those in Equation (2) in the second example embodiment.

DEᵢ represents a travel state and for example, is a vector quantity taking values of factors being road information, weather information, a road surface state, and a vehicle state as components.

For example, a value predetermined in association with whether chains are attached is preferably set to a value related to existence of chains attached to tires. Specifically, for example, it is preferable that a state of chains being attached be represented by “1,” and a state of chains not being attached be represented by “0.”

K(X, Y, Z) is an emission factor for a vehicle type X, a travel state Y, and a travel environment Z and for example, is an amount of CO₂ emission per unit time from a vehicle C with the vehicle type X, the travel state Y, and the travel environment Z. As described above, K(X, Y, Z) is a function determined for each vehicle type X. K(X, Y, Z) takes a travel state Y including one or a plurality of factors and a travel environment Z including one or a plurality of factors as variables.

Examples of factors included in the travel state Y include travel velocity, acceleration, an idling-stop state, and a loaded amount. Examples of factors included in the travel environment Z include the inclination of a road R, a curve of the road R, the number of lanes of the road R, the lane in which the vehicle C travels, installation status of CO₂ absorbers in buildings and the like around the road, existence of snow on the road surface, freezing of the road surface, wind force, precipitation, and existence of chains.

It is preferable that the evaluation apparatus 402 be physically configured similarly to the evaluation apparatus 202 according to the second example embodiment.

The operation of the evaluation system 400 may be mostly similar to the operation of the evaluation system 200 according to the second example embodiment except that the evaluation model applied in Step S202 in the second example embodiment is different as described above. Note that travel environment information may be previously acquired by the environment information acquisition unit 426 or may be acquired by the environment information acquisition unit 426 at an appropriate timing before Step S202, based on image information (state information) from an image capture unit 101.

Travel environment information is acquired according to this modified example. Thus, a travel state can be included in input data to the evaluation model. Accordingly, an amount of greenhouse gas emission from a vehicle C on a road R can be more accurately evaluated.

### Modified Example 6

An example of an evaluation apparatus with a function of generating an evaluation model by machine learning will be described in this modified example.

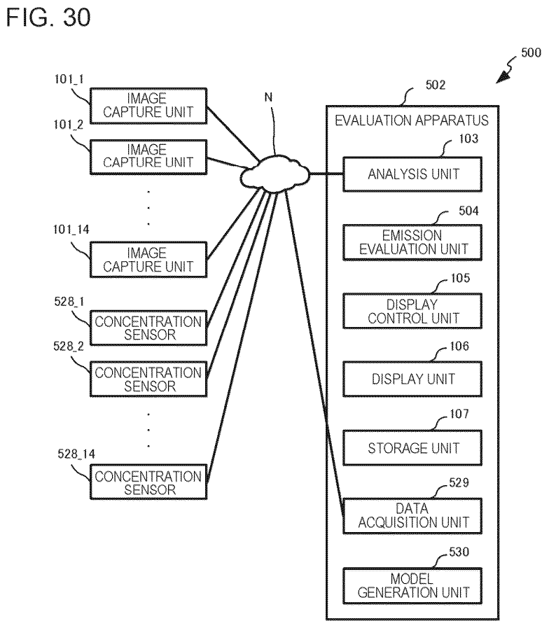

As illustrated in FIG. 30, an evaluation system 500 according to this modified example includes an evaluation apparatus 502 replacing the evaluation apparatus 102 according to the first example embodiment. The evaluation system 500 further includes concentration sensors 528_01 to 528_14. Each of the concentration sensors 528_01 to 528_14 is connected to the evaluation apparatus 102 through a network N and can transmit and receive information to and from the evaluation apparatus 502.

The concentration sensors 528_01 to 528_14 are respectively provided in association with surveilled regions P1 to P14, and respectively measure atmospheric CO₂ concentration in the associated surveilled regions P1 to P14. Each of the concentration sensors 528_01 to 528_14 transmits measurement data including measured CO₂ concentration and the region ID of a related surveilled region P to the evaluation apparatus 502 through the network N.

Unless being particularly distinguished from each other, the “concentration sensors 528_01 to 528_14” are hereinafter also expressed as “concentration sensors 528.”

Note that while an example of one concentration sensor 528 being associated with each of the surveilled regions P1 to P14 will be described in the present example embodiment, a plurality of concentration sensors 528 may be provided in association with each of the surveilled regions P1 to P14.

The evaluation apparatus 502 according to this modified example functionally includes an emission evaluation unit 504 replacing the emission evaluation unit 104 according to the first example embodiment, as illustrated in FIG. 30. The evaluation apparatus 502 further includes a data acquisition unit 529 and a model generation unit 530.

The emission evaluation unit 504 uses an evaluation model trained by machine learning in order to evaluate an amount of greenhouse gas emission accompanying travel of one or more vehicles C traveling on a road R in a surveilled region P. The emission evaluation unit 504 is preferably configured similarly to the emission evaluation unit 104 according to the first example embodiment except that the evaluation model used in evaluation of an amount of emission differs from that in the emission evaluation unit 104 according to the first example embodiment.

Specifically, the evaluation model according to this modified example is a model for evaluating an amount of greenhouse gas emission accompanying travel of a vehicle C in each surveilled region P with an analysis result generated by an analysis result generation unit 112 as input data, similarly to the first example embodiment. As a result of evaluation, the evaluation model outputs an evaluation value of an amount of greenhouse gas emission (such as an estimated value of an amount of CO₂ emission) accompanying travel of a vehicle C in each surveilled region P.

The evaluation model according to this modified example also includes a model for each vehicle type, similarly to the first example embodiment. When an analysis result is input, the evaluation model outputs an estimated value of an amount of CO₂ emission for each of one or more vehicles C traveling on a road R in a surveilled region P. Further, the emission evaluation unit 504 finds an estimated value of an amount of CO₂ emission from all of the one or more vehicles traveling on the road R in the surveilled region P by finding the total sum of estimated values of amounts of CO₂ emission found for the vehicles C.

The data acquisition unit 529 acquires measurement data related to an amount of greenhouse gas emission from a vehicle C. The data acquisition unit 529 according to the present example embodiment acquires measurement data including atmospheric CO₂ concentration in a surveilled region P and the region ID from a concentration sensor 528 through the network N.

The model generation unit 530 generates an evaluation model used by the emission evaluation unit 104. Specifically, the model generation unit 530 uses training data including an evaluation value based on measurement data generated by a concentration sensor 528. The model generation unit 530 generates an evaluation model by performing machine learning in such a way as to output an evaluation value included in training data in response to input of an analysis result at a time related to the training data.

For example, when an evaluation value is an estimated value of an amount of CO₂ emission accompanying travel of a vehicle C, an evaluation value based on measurement data is an amount of CO₂ emission estimated from CO₂ concentration included in the measurement data. For example, an experimentally acquired conversion formula is preferably used in estimation of an amount of CO₂ emission based on CO₂ concentration. Such training data are created by the model generation unit 530. Note that the training data may be created by an unillustrated external apparatus and be input to the model generation unit 530.

It is preferable that the evaluation apparatus 502 be physically configured similarly to the evaluation apparatus 102 according to the second example embodiment.

The operation of the evaluation system 500 includes evaluation processing similar to the evaluation processing according to the first example embodiment. Note that the evaluation processing differs from the evaluation processing according to the first example embodiment in that an evaluation model trained by machine learning is applied to the evaluation processing.

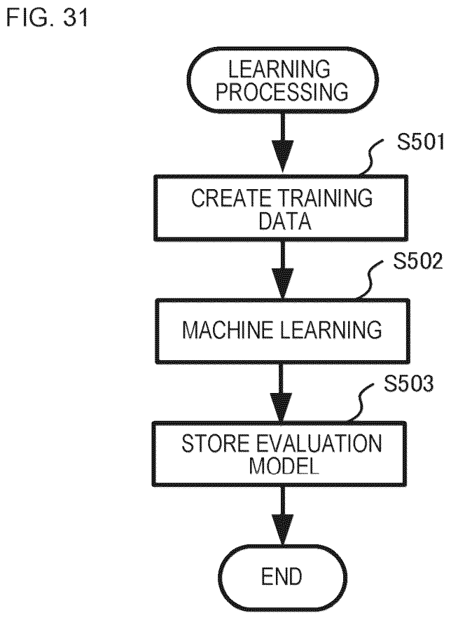

The evaluation apparatus 502 executes learning processing in this modified example. The learning processing is processing for generating an evaluation model and for example, is started in accordance with an instruction from a user. FIG. 31 is an example of a flowchart of the learning processing according to this modified example.

When acquiring measurement data, the model generation unit 530 estimates an amount of CO₂ emission accompanying travel of a vehicle C from CO₂ concentration included in the measurement data. Thus, the model generation unit 530 creates training data including the estimated amount of CO₂ emission (Step S501).

The model generation unit 530 inputs the analysis result generated in Step S101c to an evaluation model, based on state information at the same time as the time of generation of the measurement data. In response to the input of the analysis result, the model generation unit 530 performs machine learning in such a way as to output an evaluation value included in the training data. Thus, the model generation unit 530 generates an evaluation model (Step S502).

The model generation unit 530 stores the evaluation model generated in Step S502 into the storage unit 107 (Step S503) and ends the learning processing. At this time, data including a parameter set employed in the evaluation model generated in Step S502 are preferably stored in the storage unit 107.

According to this modified example, an evaluation model is generated by machine learning based on measurement data. Since measurement data are an actual measurement, an evaluation model that can more accurately predict an actual amount of CO₂ emission can be generated. Accordingly, an amount of greenhouse gas emission from a vehicle C on a road R can be more accurately evaluated.

While the example embodiments of the present invention and the modified examples thereof have been described above with reference to the drawings, the example embodiments and the modified examples thereof are exemplifications of the present invention, and various configurations other than those described above may be employed.

Further, while a plurality of processes (processing) are described in a sequential order in each of a plurality of flowcharts used in the aforementioned description, the execution order of processes executed in each example embodiment is not limited to the order of description. The order of the illustrated processes may be modified without affecting the contents in each example embodiment. Further, the aforementioned example embodiments and the modified examples thereof may be combined without contradicting each other.

The whole or part of the example embodiments disclosed above may also be described as, but not limited to, the following supplementary notes.

1. A greenhouse gas emission evaluation apparatus including:
an analysis unit that generates an analysis result including vehicle types of one or more vehicles by analyzing state information indicating states of the one or more vehicles traveling on a road; and
an emission evaluation unit that evaluates an amount of greenhouse gas emission accompanying travel of the one or more vehicles by using an evaluation model for evaluating an amount of greenhouse gas emission accompanying travel of a vehicle with the analysis result as input data.
   2. The greenhouse gas emission evaluation apparatus according to supplementary note 1, wherein
the evaluation model includes a model for each vehicle type for evaluating an amount of greenhouse gas emission accompanying travel of a vehicle, and
the emission evaluation unit evaluates an amount of greenhouse gas emission accompanying travel of each of the one or more vehicles by using a model based on a vehicle type of each of one or more vehicles included in the analysis result with the analysis result as input data.
   3. The greenhouse gas emission evaluation apparatus according to supplementary note 2, wherein
the emission evaluation unit evaluates an amount of greenhouse gas emission accompanying travel of a vehicle by further finding a total sum of evaluation values of respective amounts of greenhouse gas emission accompanying travel of the one or more vehicles.
   4. The greenhouse gas emission evaluation apparatus according to any one of supplementary notes 1 to 3, wherein
the state information includes at least one item out of image information acquired by capturing an image of the road and vehicle information about a vehicle traveling on the road, the vehicle information being generated by an on-vehicle apparatus equipped on the vehicle.
   5. The greenhouse gas emission evaluation apparatus according to any one of supplementary notes 1 to 4, wherein
the analysis result further includes at least one item out of travel velocity of the vehicle, a rate of change of travel velocity of the vehicle, an idling-stop state of the vehicle, and a loaded amount being a total weight of a person on board the vehicle and baggage loaded on the vehicle.
   6. The greenhouse gas emission evaluation apparatus according to any one of supplementary notes 1 to 5, further including
an environment information acquisition unit that acquires travel environment information being information about a travel environment of the road, wherein
the emission evaluation unit evaluates an amount of greenhouse gas emission accompanying travel of the one or more vehicles by using an evaluation model for evaluating an amount of greenhouse gas emission accompanying travel of a vehicle with the analysis result and the travel environment information as input data.
   7. The greenhouse gas emission evaluation apparatus according to supplementary note 6, wherein
the travel environment information includes at least one item out of road information, weather information, a road surface state, and a vehicle state.
   8. The greenhouse gas emission evaluation apparatus according to any one of supplementary notes 1 to 7, wherein
the vehicle type includes a type based on a composition of drive energy used by a vehicle.
   9. The greenhouse gas emission evaluation apparatus according to supplementary note 8, wherein
the evaluation model includes a model evaluating an amount of greenhouse gas emission accompanying travel of the vehicle by using at least one of a generation cost and a transportation cost of drive energy supplied to a vehicle.
   10. The greenhouse gas emission evaluation apparatus according to any one of supplementary notes 1 to 9, further including:
a measurement data acquisition unit that acquires measurement data related to an amount of greenhouse gas emission from a vehicle; and
a model generation unit that generates the evaluation model, wherein
the model generation unit generates the evaluation model by performing, by using training data including an evaluation value based on the measurement data, machine learning in such a way as to output an evaluation value included in the training data in response to input of the analysis result.
   11. The greenhouse gas emission evaluation apparatus according to any one of supplementary notes 1 to 10, further including
a display control unit that outputs display information including an evaluation map indicating a result of evaluation by the emission evaluation unit on a map in order to cause a display unit to display the display information.
   12. The greenhouse gas emission evaluation apparatus according to any one of supplementary notes 1 to 11, further including
a vehicle evaluation output unit that transmits individual evaluation information including a result of evaluation for each vehicle by the emission evaluation unit to a related vehicle.
   13. A greenhouse gas emission evaluation system including:
at least one of an image capture unit that generates image information acquired by capturing an image of the road as the state information and an on-vehicle apparatus that generates vehicle information about a vehicle traveling on the road as the state information; and
the greenhouse gas emission evaluation apparatus according to any one of supplementary notes 1 to 12
   14. A greenhouse gas emission evaluation method including:
generating an analysis result by analyzing state information indicating states of one or more vehicles traveling on a road; and
evaluating an amount of greenhouse gas emission accompanying travel of the vehicle by using an evaluation model for evaluating an amount of greenhouse gas emission accompanying travel of a vehicle with the analysis result as input data.
   15. A program causing a computer to execute:
generating an analysis result by analyzing state information indicating states of one or more vehicles traveling on a road; and
evaluating an amount of greenhouse gas emission accompanying travel of the vehicle by using an evaluation model for evaluating an amount of greenhouse gas emission accompanying travel of a vehicle with the analysis result as input data.
   16. A storage medium on which a program is recorded, the program causing a computer to execute:
generating an analysis result by analyzing state information indicating states of one or more vehicles traveling on a road; and
evaluating an amount of greenhouse gas emission accompanying travel of the vehicle by using an evaluation model for evaluating an amount of greenhouse gas emission accompanying travel of a vehicle with the analysis result as input data.

### REFERENCE SIGNS LIST

P, P1 to P14 Surveilled region
R, R1 to R4 Road
C Vehicle
100, 200, 300, 400, 500 Greenhouse gas emission evaluation system
101, 101_1 to 101_14 Image capture unit
102, 202, 302, 402, 502 Greenhouse gas emission evaluation apparatus
103, 203 Analysis unit
104, 204, 404, 504 Emission evaluation unit
105 Display control unit
106 Display unit
107 Storage unit
110 Information acquisition unit
111 Vehicle type analysis unit
112, 212 Analysis result generation unit
117, 217 First evaluation unit
118 Second evaluation unit
120 Vehicle model data
222 Travel state analysis unit
301, 301_1 to 301_k On-vehicle apparatus
426 Environment information acquisition unit
528, 528_1 to 528_14 Concentration sensor
529 Data acquisition unit
530 Model generation unit

What is claimed is:

1. A greenhouse gas emission evaluation apparatus comprising:
at least one memory configured to store instructions; and
at least one processor configured to execute the instructions to:
generate an analysis result including vehicle types of one or more vehicles by analyzing state information indicating states of the one or more vehicles traveling on a road; and
evaluate an amount of greenhouse gas emission accompanying travel of the one or more vehicles by using an evaluation model for evaluating an amount of greenhouse gas emission accompanying travel of a vehicle with the analysis result as input data.

2. The greenhouse gas emission evaluation apparatus according to claim 1, wherein
the evaluation model includes a model for each vehicle type for evaluating an amount of greenhouse gas emission accompanying travel of a vehicle, and
the amount of greenhouse gas emission accompanying travel of each of the one or more vehicles is evaluated by using the model based on a vehicle type of each of one or more vehicles included in the analysis result with the analysis result as input data.

3. The greenhouse gas emission evaluation apparatus according to claim 2, wherein
the amount of greenhouse gas emission accompanying travel of a vehicle is evaluated by further finding a total sum of evaluation values of respective amounts of greenhouse gas emission accompanying travel of the one or more vehicles.

4. The greenhouse gas emission evaluation apparatus according to claim 1, wherein
the state information includes at least one item out of image information acquired by capturing an image of the road and vehicle information about a vehicle traveling on the road, the vehicle information being generated by an on-vehicle apparatus equipped on the vehicle.

5. The greenhouse gas emission evaluation apparatus according to claim 1, wherein
the analysis result further includes at least one item out of travel velocity of the vehicle, a rate of change of travel velocity of the vehicle, an idling-stop state of the vehicle, and a loaded amount being a total weight of a person on board the vehicle and baggage loaded on the vehicle.

6. The greenhouse gas emission evaluation apparatus according to claim 1, the at least one processor configured further to execute the instructions to:
acquire travel environment information being information about a travel environment of the road, wherein
the amount of greenhouse gas emission accompanying travel of the one or more vehicles is evaluated by using the evaluation model for evaluating the amount of greenhouse gas emission accompanying travel of the vehicle with the analysis result and the travel environment information as input data.

7. The greenhouse gas emission evaluation apparatus according to claim 6, wherein
the travel environment information includes at least one item out of road information, weather information, a road surface state, and a vehicle state.

8. The greenhouse gas emission evaluation apparatus according to claim 1, wherein
the vehicle type includes a type based on a composition of drive energy used by a vehicle.

9. The greenhouse gas emission evaluation apparatus according to claim 1, wherein
the evaluation model includes a model evaluating the amount of greenhouse gas emission accompanying travel of the vehicle by using at least one of a generation cost and a transportation cost of drive energy supplied to a vehicle.

10. The greenhouse gas emission evaluation apparatus according to claim 1, the at least one processor configured further to execute the instructions to:
acquire measurement data related to an amount of greenhouse gas emission from a vehicle; and
generate the evaluation model, wherein
the evaluation model is generated by performing, by using training data including an evaluation value based on the measurement data, machine learning in such a way as to output an evaluation value included in the training data in response to input of the analysis result.

11. The greenhouse gas emission evaluation apparatus according to claim 1, the at least one processor configured further to execute the instructions to:
output display information including an evaluation map indicating a result of evaluation of the amount of greenhouse gas emission unit on a map in order to cause a display to display the display information.

12. The greenhouse gas emission evaluation apparatus according to claim 1, the at least one processor configured further to execute the instructions to:
transmit individual evaluation information including a result of evaluation of the amount of greenhouse gas emission for each vehicle to a related vehicle.

13. A greenhouse gas emission evaluation system comprising:
at least one of a camera that generates image information acquired by capturing an image of the road as the state information and an on-vehicle apparatus that generates vehicle information about a vehicle traveling on the road as the state information; and
the greenhouse gas emission evaluation apparatus according to claim 1.

14. A greenhouse gas emission evaluation method comprising:
generating an analysis result by analyzing state information indicating states of one or more vehicles traveling on a road; and
evaluating an amount of greenhouse gas emission accompanying travel of the vehicle by using an evaluation model for evaluating an amount of greenhouse gas emission accompanying travel of a vehicle with the analysis result as input data.

15. A non-transitory storage medium on which a program is recorded, the program causing a computer to execute:
generating an analysis result by analyzing state information indicating states of one or more vehicles traveling on a road; and
evaluating an amount of greenhouse gas emission accompanying travel of the vehicle by using an evaluation model for evaluating an amount of greenhouse gas emission accompanying travel of a vehicle with the analysis result as input data.
